(19) United States
(12) Patent Application Publication
(10) Pub. No.: US 2007/0271186 A1
(43) Pub. Date: Nov. 22, 2007

(54) Content distribution service providing system and content distribution device and user terminal device thereof

(75) Inventors: Shinichi Kurihara, Yokohama-shi (JP); Hiroaki Unno, Kunitachi-shi (JP); Taku Kato, Kamakura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba, Tokyo (JP)

(21) Appl. No.: 11/878,245

(22) Filed: Jul. 23, 2007

Related U.S. Application Data
(62) Division of application No. 10/996,400, filed on Nov. 26, 2004.

(30) Foreign Application Priority Data
Nov. 26, 2003 (JP) 2003-395897

(51) Int. Cl. G06Q 30/00; H04K 1/00

(52) U.S. Cl. 705/51; 705/52

(57) ABSTRACT

A content distribution device carries out distribution services of contents whose copyright protection is required via a communication line, to a user terminal device that enables to record contents to an information storage medium in which medium information is written, when receiving a content distribution request from the user terminal device, distributes a content list, and receives content selection information. At that moment, the content distribution device acquires the medium information from the user terminal device, sends this medium information to an encoded content key issuing device and receives an encoded content key based on the medium information concerned, and encodes contents by this encoded content key and distributes them to the user terminal device as distribution request source. The encoded content key is to be distributed at every viewing and/or listening request from the user terminal device, and when viewing and/or listening valid period expires, key distribution is stopped.

### CROSS-REFERENCE TO RELATED APPLICATIONS

This application is based upon and claims the benefit of priority from the prior Japanese Patent Application No. 2003-395897, filed Nov. 26, 2003, the entire contents of which are incorporated herein by reference.

### BACKGROUND OF THE INVENTION

1. Field of the Invention

The present invention relates to a content distribution service system that conducts distribution services of contents whose copyright protection is required via a communication line, and a content distribution device that distributes the contents thereof and a user terminal device that receives the services thereof.

2. Description of the Related Art

In recent years, the development of communication technologies in internet and the like, data compression technologies by digital signal processing, and so forth, has enabled to distribute large amounts of data of contents including music pieces, movies, games and the like by use of communication lines, and content distribution services can be received at anytime and anywhere.

In a system to realize the content distribution services, it is general that a person who wants to purchase or view and/or listen to contents (hereinafter, a user) accesses a content distribution center that distributes contents that the user wants from a communication terminal device such as a personal computer (hereinafter, PC) or a set top box (STB) (hereinafter, user terminal device), and informs a request to purchase or view or listen to contents according to a menu screen, and thereby downloads or replays or views and/or listens to contents.

However, at present, setting procedures that the user has to take before receiving services via the user terminal device are not so easy as those for household electric appliances. Copyright holders (or copyright controllers, hereinafter collectively referred to as copyright holders) of contents of popularity and topics are still reluctant to distribute their contents to user terminal devices via communication lines because they are afraid of unauthorized copies, and an effective structure that enables to distribute or view and/or listen to contents of popularity and topics that users want and which gains trust of copyright holders has not been realized yet. Even if distribution of contents of popularity and topics is made possible, distribution must be conducted after payment of high minimum guarantee money to copyright holders, which makes it difficult to realize content distribution as a profitable business.

In addition to these problems, there may be a case where to requests of quickly selecting contents and viewing and/or listening to them, load states of communication lines prevent stable viewing and/or listening. Further, when a user wants to view and/or listen to contents for plural times at a specific period, the user must acquire contents via a communication line at every time, which causes loads on the communication line, leading to high costs of communication infrastructure, which has been a problem in the prior art.

Jpn. Pat. Appln. KOKAI Publication No. 2002-196982 discloses an information storage medium and a recording/replaying device therefor that enables to protect copyrighted content data from unauthorized use, and to record data in authorized manners. The contents of the disclosure are that a controller is arranged at a place separated from a content recording area of the information storage medium, and only in combination of a predetermined information storage medium itself and a controller corresponding thereto, content data in the information storage medium may be used, thereby it is possible to keep the information storage medium handy and also to realize complicated security functions. This technology is to solve the problem of unauthorized use of recording of copyrighted content data, and lacks consideration for convenience or security measures for realizing distribution services of content data via communication lines.

Meanwhile, Jpn. Pat. Appln. KOKAI Publication No. 2002-222285 discloses a system that, in distribution of electronic documents corresponding to copyrighted content data, reduces loads on a network owing to concentrated accesses, and carries out authorization of originality by a third party organization. In content data distribution, access authorization is indispensable, but the authorization technology disclosed in the patent document 2 relates just to authorization of originality, and is different from authorization use method according to the present invention to be described later herein.

Further, Jpn. Pat. Appln. KOKAI Publication No. 10-207779 discloses a method in which, when a terminal device uses data, a registration number is sent to an information control center and a determination is made, and a use permission of digital information is sent to the terminal device. In the case of this method, no consideration is made on protection of digital information itself stored in the terminal device, therefore it is different from the present invention where a key that enables to decode digital information itself on the basis of medium information of an information storage medium is encoded and sent.

Further, Jpn. Pat. Appln. KOKAI Publication No. 2003-022339 discloses a method in which, by use of a structure of a storage medium having a protection area and a data area and a content replay device, a use period of contents is designated and unauthorized content use is prevented. In the case of this method, use period information is stored in the protective area of the storage medium, and determination whether to replay or not is made on this information. Therefore it is different from the present invention that enables viewing and/or listening limitation on the basis of use limitation information per user and medium information of information storage media via communication lines. For example, the method fails to provide flexible services in connection with service charge control such as an expansion of a viewing and/or listening period. Further, in the method, it is necessary to hold a timer for referring to the current date and time at the content replay device, which causes more costs of a terminal device than the present invention where a timer under uniform management by a content distribution device is employed.

Further, Jpn. Pat. Appln. KOKAI Publication No. 2001-258009 discloses a method in which a terminal individual ID given per device is sent to a center, and content control information including information to determine whether it is within a replay permission period or not by use of this ID is encoded. In the case of this method, the terminal individual ID given per device is used as conditions for encoding and decoding, therefore it is different from the present invention that enables viewing and/or listening limitations on the basis of medium information of information storage media via communication lines.

Still further, in Jpn. Pat. Appln. KOKAI Publication No. 2003-174439, a method is disclosed in which validity term information is added to a decoding key of encoded data. However it is different from the present invention where it is determined and controlled whether to sent or not an encoded content key itself that enables to decode encoded contents by a reference time under uniform management by a content distribution device.

### BRIEF SUMMARY OF THE INVENTION

As mentioned above, content distribution services are not so spread as to meet market requirements even though they have requests from users and attractive features of business purposes, owing to problems of troublesome settings before service distribution, unauthorized distribution, difficulties in stable viewing and/or listening, difficulties in effective distribution in viewing and/or listening limit periods.

The present invention has been made in consideration of the above problems in the prior art, accordingly, the object of the present invention is to provide a content distribution service providing system and a content distribution device thereof and a user terminal device thereof that has a structure of copyright protection to prevent unauthorized distribution of contents, and enables to gain reliability from copyright holders or copyright controllers of contents, and to realize effective content distribution services that realize stable viewing and/or listening by use of communication lines at reasonable prices, effective viewing and/or listening time limit control and distribution to user terminals, and efficient distribution within viewing and/or listening time limit.

A content distribution service providing system according to the present invention is characterized by comprising the following content distribution device and user terminal device.

First, the content distribution device is a device for carrying out distribution services of contents whose copyright protection is required via a communication line, to a user terminal device that enables to record contents to an information storage medium in which medium information of a medium specific identifier and medium key information are written, or to another information storage medium different from the information storage medium in a status where the information storage medium is set, and is characterized by comprising: content distribution request acquisition means for receiving a content distribution request based on a content selection list to be distributed in advance, from the user terminal device; viewing and/or listening condition acquisition means for distributing a viewing and/or listening condition list including at least one of a viewing and/or listening valid period and the number of viewing and/or listening times to the user terminal device that has made the request at receiving of the content distribution request, and receiving a viewing and/or listening condition selection result thereof; medium information control means for acquiring and controlling the medium information from the user terminal device; encoded content control means for encoding and controlling contents specified in the content selection list by a specified content key, and distributing encoded contents corresponding to the content distribution request to the user terminal device that has made the request; encoded content key acquisition means for sending the medium information to an encoded content key issuing device, asking it to encode a content key used in encoding the distribution contents on the basis of the medium information and device specific key information registered in advance, and receiving the encoded content key; encoded content key distribution means for distributing an encoded content key corresponding to the user terminal that has made a viewing and/or listening request according to a viewing and/or listening request for already distributed encoded contents, from the user terminal device; and user control means for controlling the viewing and/or listening conditions in unit of user, and determining whether viewing and/or listening conditions are satisfied or not at the viewing and/or listening request, wherein the encoded content key distribution means distributes the encoded content key only when it is determined that viewing and/or listening conditions are satisfied at the viewing and/or listening request.

Meanwhile, the user terminal device is a device that is used in a system for carrying out distribution services of contents whose copyright protection is required via a communication line from the content distribution device, and enables to record contents to an information storage medium in which medium information of a medium specific identifier and medium key information are written, or to another information storage medium different from the information storage medium in a status where the information storage medium is set, and is characterized by comprising: content distribution request means for requesting the content distribution device to distribute contents according to a content selection list to be distributed in advance; viewing and/or listening condition instruction means for selecting and instructing an arbitrary viewing and/or listening condition from a viewing and/or listening condition list including at least one of a viewing and/or listening valid period and the number of viewing and/or listening times distributed from the content distribution device at the content distribution request; medium information sending means for sending medium information to the content distribution device; content recording means for receiving encoded contents distributed from the content distribution device, and recording the contents to the information storage medium; encoded content key acquisition means for sending a viewing and/or listening request to the content distribution device at start of viewing and/or listening to the recorded contents and acquiring the encoded content key; and decoding and replaying means for generating a content key from the encoded content key on the basis of the medium information and device specific key information registered in advance, and decoding and replaying encoded contents read from the information storage medium by the content key.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A, 1B, 1C, 1D and 1E are a schematic diagram showing an embodiment of a content distribution service providing system according to the present invention;

FIG. 2 is a flow chart showing processing procedures of a service subscription application accepting unit and a terminal registration authorization information issuing unit of a content distribution device shown in FIG. 1A;

FIG. 3 is a flow chart showing processing procedures of a device information registering unit of the content distribution device shown in FIG. 1A;

FIG. 4 is a flow chart showing processing procedures of a user authorizing unit of the content distribution device shown in FIG. 1A;

FIG. 5 is a flow chart showing processing procedures of a user control unit of the content distribution device shown in FIG. 1A;

FIG. 6 is a flow chart showing processing procedures of the user control unit of the content distribution device shown in FIG. 1A;

FIG. 7 is a flow chart showing processing procedures of the user control unit of the content distribution device shown in FIG. 1A;

FIG. 8 is a flow chart showing processing procedures of the user control unit of the content distribution device shown in FIG. 1A;

FIG. 9 is a flow chart showing processing procedures of the content distribution device shown in FIG. 1A;

FIG. 10 is a flow chart showing processing procedures of the user control unit of the content distribution device shown in FIG. 1A;

FIG. 11 is a flow chart showing processing procedures of an encoded content key acquiring unit of the content distribution device shown in FIG. 1A;

FIG. 12 is a flow chart showing processing procedures of an encoded content key issuing device shown in FIG. 1D;

FIG. 13 is a flow chart showing processing procedures of the encoded content key acquiring unit of the content distribution device shown in FIG. 1A;

FIG. 14 is a flow chart showing processing procedures of the user control unit of the content distribution device shown in FIG. 1A;

FIG. 15 is a flow chart showing processing procedures of a divided encoded content distributing unit of the content distribution device shown in FIG. 1A;

FIG. 16 is a flow chart showing processing procedures of the divided encoded content distributing unit of the content distribution device shown in FIG. 1A;

FIG. 17 is a flow chart showing processing procedures of the user control unit of the content distribution device shown in FIG. 1A;

FIG. 18 is a flow chart showing processing procedures of the user control unit of the content distribution device shown in FIG. 1A;

FIG. 19 is a flow chart showing processing procedures of an encoded key information distributing unit of the content distribution device shown in FIG. 1A;

FIG. 20 is a flow chart showing processing procedures of the user control unit of the content distribution device shown in FIG. 1A;

FIG. 21 is a flow chart showing processing procedures of a device information issuing unit of a user terminal device shown in FIG. 1B;

FIG. 22 is a flow chart showing processing procedures of the device information issuing unit of the user terminal device shown in FIG. 1B;

FIG. 23 is a flow chart showing processing procedures of an authorization information issuing unit of the user terminal device shown in FIG. 1B;

FIG. 24 is a flow chart showing processing procedures of the authorization information issuing unit of the user terminal device shown in FIG. 1B;

FIG. 25 is a flow chart showing processing procedures of a viewing and/or listening request control unit of the user terminal device shown in FIG. 1B;

FIG. 26 is a flow chart showing processing procedures of the viewing and/or listening request control unit of the user terminal device shown in FIG. 1B;

FIG. 27 is a flow chart showing processing procedures of the viewing and/or listening request control unit of the user terminal device shown in FIG. 1B;

FIG. 28 is a flow chart showing processing procedures of an encoded content acquisition processing unit of the user terminal device shown in FIG. 1C;

FIG. 29 is a flow chart showing processing procedures of an encoded content key information acquisition processing unit of the user terminal device shown in FIG. 1C;

FIG. 30 is a flow chart showing processing procedures of a content viewing and/or listening unit of the user terminal device shown in FIG. 1C;

FIG. 31 is a flow chart showing processing procedures of the content viewing and/or listening unit of the user terminal device shown in FIG. 1C; and

FIGS. 32A, 32B and 32C are figures showing visual representations of content accumulation states and viewing and/or listening states of the content viewing and/or listening unit of the user terminal device shown in FIG. 1C.

### DETAILED DESCRIPTION OF THE INVENTION

An embodiment of the present invention will be illustrated in more details by reference to the accompanying drawings.

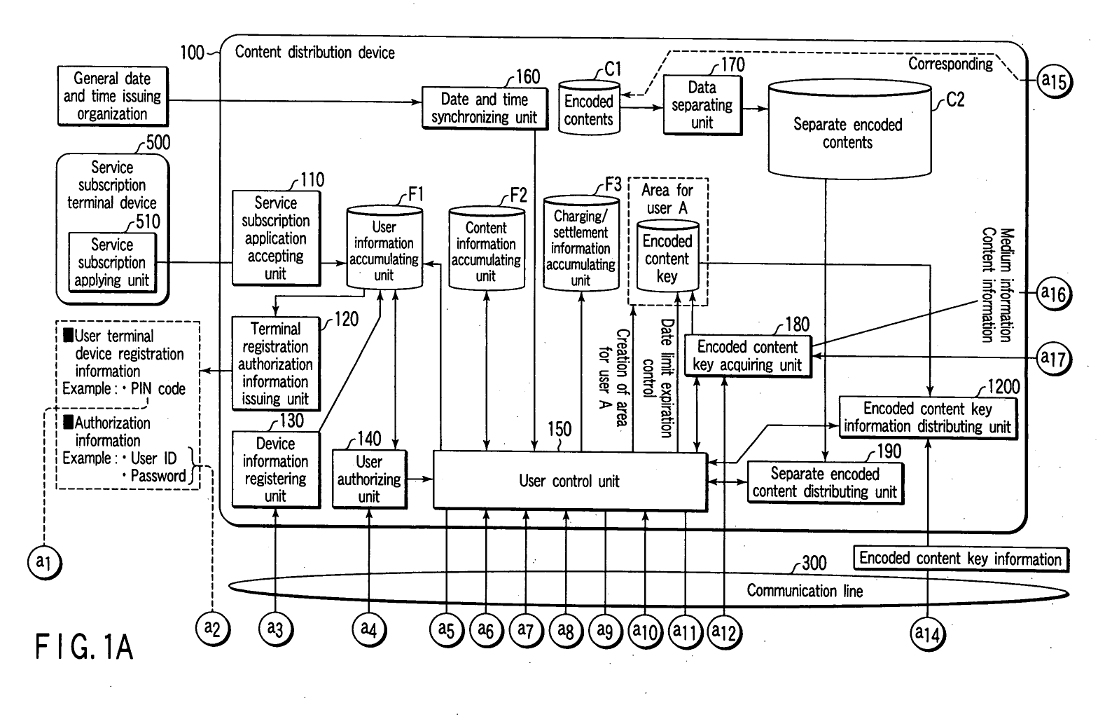

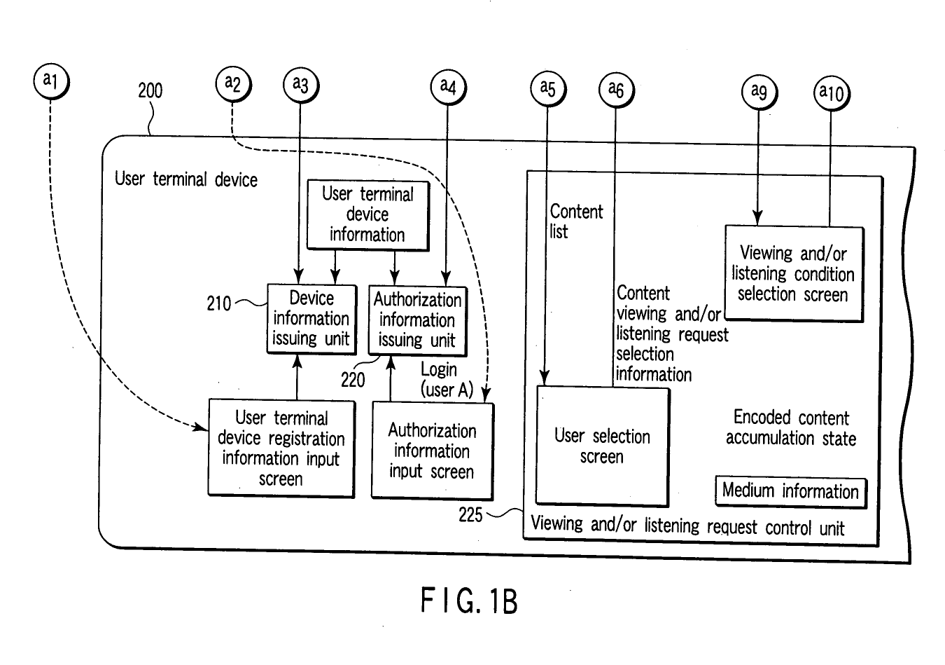

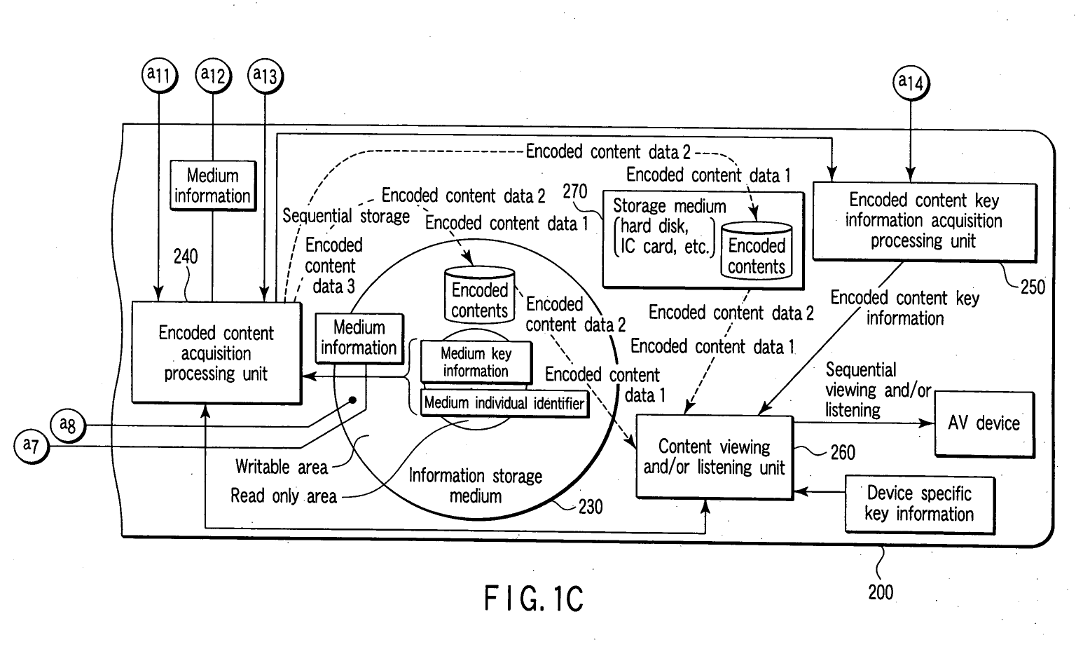

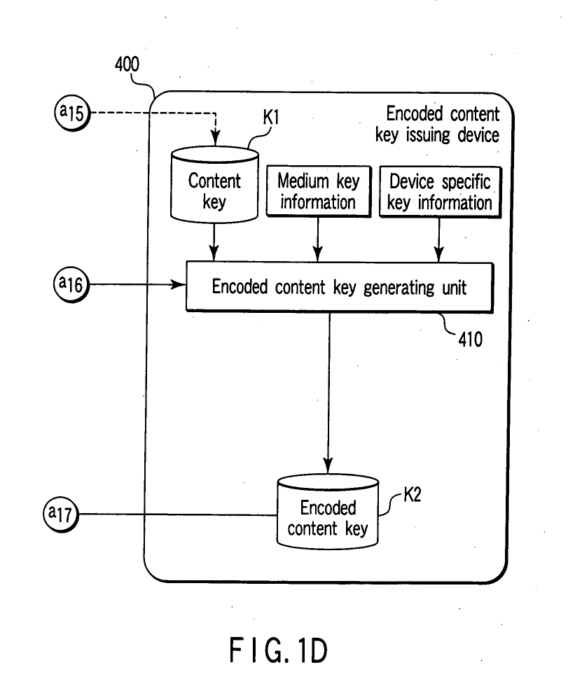

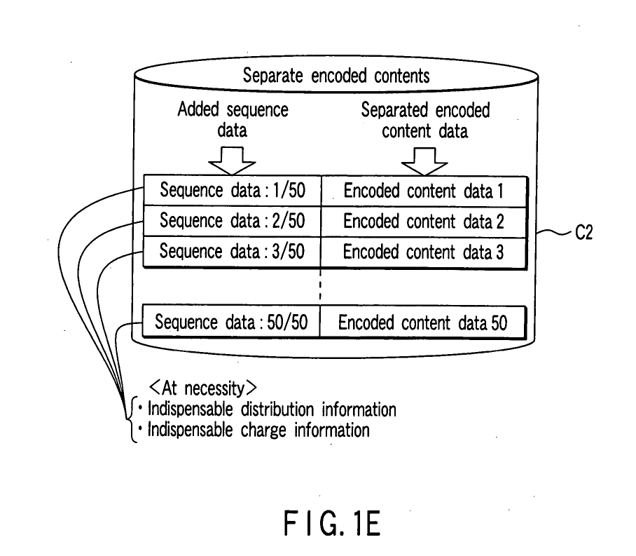

FIGS. 1A, 1B, 1C, 1D and 1E are a schematic diagram showing an embodiment of a content distribution service providing system according to the present invention, FIG. 1A shows a content distribution device 100, FIG. 1B shows a part of user terminal device 200, FIG. 1C shows the remaining part of user terminal device 200, FIG. 1D shows encoded content key issuing device 400, and FIG. 1E shows information contents of divided encoded contents C2. In this system, it is supposed that the Content Protection for Recordable Media (CPRM) Specification is applied on a network, as an encoding processing technology for the purpose of copyright protection. In this CPRM Specification, a key block called Media Key Block (MKB) is recorded into media, and by use of this MKB and a device key prepared to a device, high level copyright protection (copyright control) is realized. Herein, medium key information, medium specific identifier, and device specific key information used in explanations of the present system correspond to an MKB, an identification number (ID), and a device key on the CPRM Specification respectively.

The system shown in FIGS. 1A, 1B, 1C, 1D and 1E comprises a content distribution device 100 that is arranged at a content distribution center, a user terminal device 200 that accesses the content distribution device 100 via a communication line 300 and thereby receives content distribution services, an encoded content key issuing device 400 that is arranged at a content key issuing center, and issues an encoded content key, and a service subscription terminal device 500 that carries out application procedures necessary for a user to receive services to the content distribution device 100.

The content distribution device 100 comprises a service subscription application accepting unit 110, a terminal registration authorization information issuing unit 120, a device information registering unit 130, a user authorizing unit 140, a user control unit 150, a date and time synchronizing unit 160, a data dividing unit 170, an encoded content key acquiring unit 180, a divided encoded content distributing unit 190, and an encoded content key information distributing unit 1200.

The user terminal device 200 comprises a device information issuing unit 210, an authorization information issuing unit 220, an information storage medium 230 having medium information (medium specific identifier and medium key information), an encoded content acquisition processing unit 240, an encoded content key information acquisition processing unit 250, a content viewing and/or listening unit 260, and an information storage medium 270 that does not have medium information (hereinafter, so as to distinguish from the information storage medium 230, referred to simply as storage medium).

The encoded content key issuing device 400 comprises an encoded content key generating unit 410. This encoded content key issuing device 400 is controlled by other provider than that of the content distribution device 100, and is connected via a communication line to the content distribution device 100, though not illustrated therein.

The service subscription terminal device 500 comprises a service subscription applying unit 510. The service subscription terminal device 500 may be replaced by a PC or so at the user side that is connectable via the communication line 300 to the content distribution device 100, and may be processed by data communications.

In the system configuration, along the flow of processes, processing contents of processing blocks configuring each device are explained hereinafter.

First, as a method for taking a service subscription application, there are methods by oral communications to an operator on telephone, submission in writing as a postal mail, and direct application via communications by the user.

In the case of receiving an oral or written service subscription application from the user, an administrator (or an operator) accesses the content distribution device 100 from the service subscription terminal device 500, and receives information concerning various requirements and payment methods necessary for a service subscription application to be issued by the service subscription application accepting unit 110 (hereinafter, subscription requirement information). In the service subscription terminal device 500, the service subscription applying unit 510 displays the application requirement information to the administrator, and the administrator inputs answer information to the requirements, then sends this answer information to the service subscription application accepting unit 110.

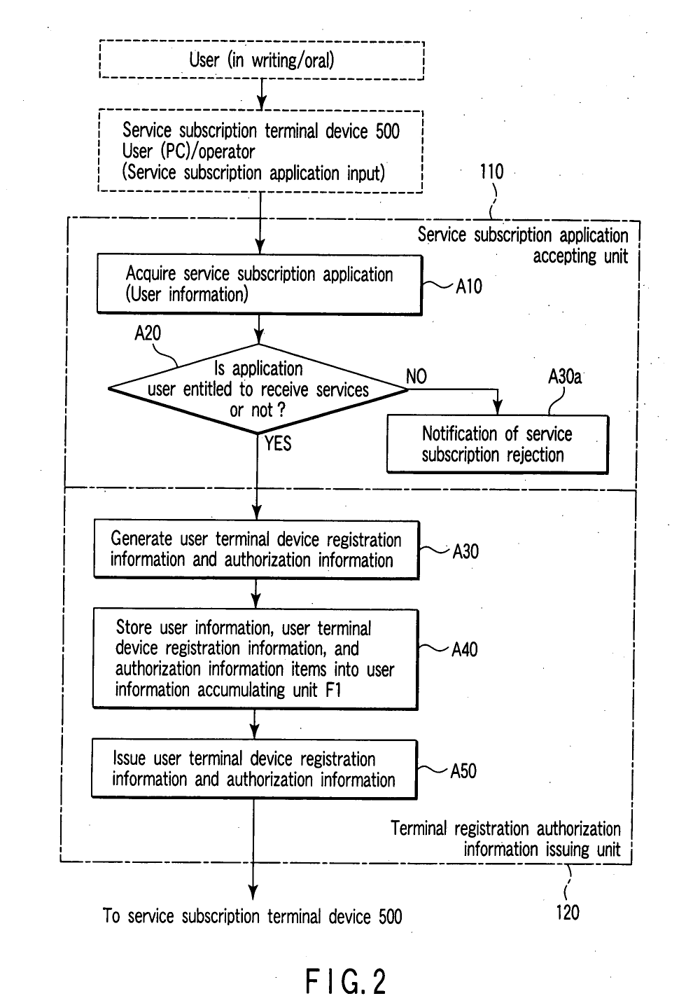

In the service subscription application accepting unit 110, as shown in FIG. 2, when the answer information of various subscription requirements necessary for service subscription application is received (A10), it is determined whether or not the application user is entitled to receive services on the basis of the answer information (A20). As a result of the determination, if it is determined that the application user is not entitled, a notification of service subscription rejection is made to the service subscription terminal device 500 and the like (A30a). On the other hand, if it is determined that the application user is entitled, subscription requirement answer information is sent to the terminal registration authorization information issuing unit 120.

In the terminal registration authorization information issuing unit 120, user terminal device registration information of PIN codes and the like are generated, and authorization information including a user ID, password and the like is generated (it is preferred that each information item is generated at random) (A30). User information as well as these information items are accumulated in a user information accumulating unit F1 (A40), the user terminal device registration information and the authorization information are issued to the service subscription terminal device 500 (A50).

In the case of direct application via PC data communications by the user, the service subscription terminal device is replaced with the user's PC, and the user becomes an operator, subscription application may be made by the same processing procedures as in FIG. 2. The user terminal device 200 may have and thereby realize the functions of the service subscription terminal device 500.

As the requirement information items necessary for service subscription application, there are, for example, user's name, date of birth, address, sex, telephone number, subscription service types (for example, only viewing and/or listening to movie contents, only viewing and/or listening to sport contents, viewing and/or listening to all the contents, and so forth). As the payment methods, there are prepaid card type, credit card type, and so on, and as their information items, there are, for example, prepaid card number, credit card number, card validity term and so forth.

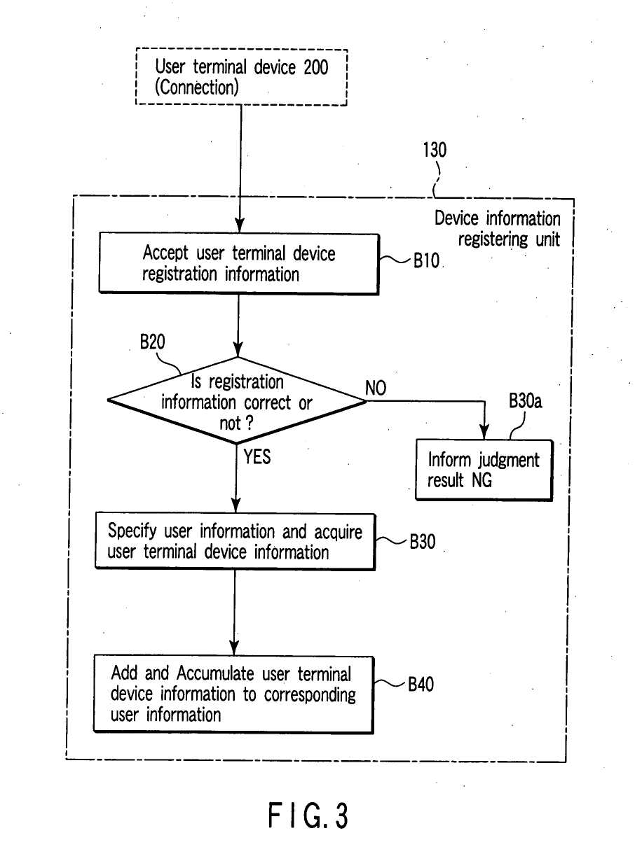

The user terminal device 200, when accessing the content distribution device 100, adds the user terminal device registration information of PIN codes and the like. In response to this, a device information registering unit 131 of the content distribution device 100, as shown in FIG. 3, accepts the user terminal device registration information (B10), and determines whether the registration information is correct or not (B20). If it is determined the registration information is correct, the corresponding user information is specified from the user information accumulating unit F1, the user terminal device information is acquired from the user terminal device 200 (B30), and the user terminal device information is added and accumulated to the user information (B40). If it is determined the registration information is not correct, the determination result (NG) is informed, and connection is shut down (B30a).

Herein, even when the user terminal device registration information is same, if the user terminal device information is different, the user terminal device information is added and accumulated to the user information.

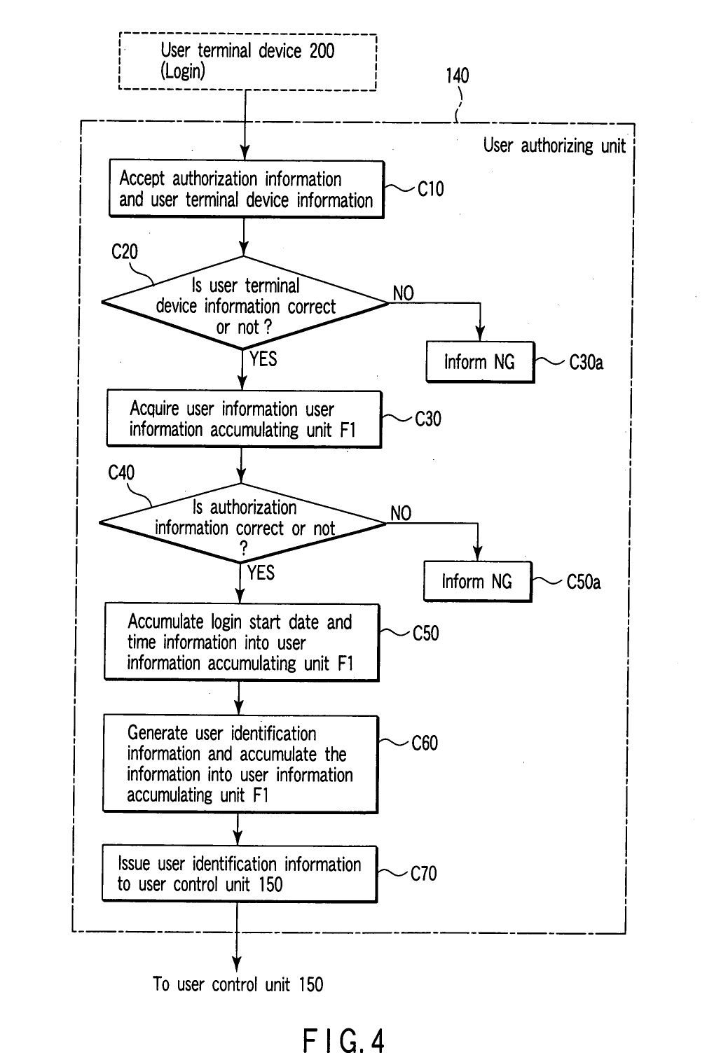

On the other hand, the user authorizing unit 140 of the content distribution device 100, as shown in FIG. 4, at login of the user terminal device 200, accepts the authorization information and the user terminal device information (C10), and determines whether the user terminal device information is correct or not (C20). If it is correct, the corresponding user information is read from the user information accumulating unit F1 (C30), and it is determined whether the authorization information is correct or not (C40). Also, if it is not correct, login start date and time information is accumulated into the user information accumulating unit F1 (C50), user identification information concerning this login is generated and accumulated into the user information accumulating unit F1 (C60), and user identification information and the like are issued to the user control unit 150 (C70). In the steps C20 and C40, if it is determined as not correct, NG is informed and connection is shut down (C30a, C50a).

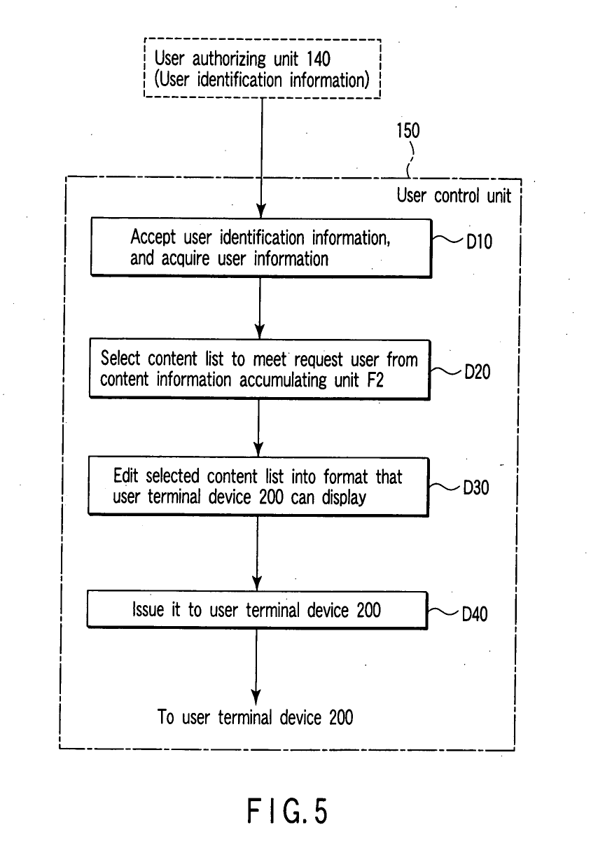

The user control unit 150, as shown in FIG. 5, accepts the issue of the user identification information and the like from the user authorizing unit 140, reads the user information registered at service subscription procedures from the user information accumulating unit F1 (D10), select a content list to meet the request user from the content information accumulating unit F2 (D20), edits the selected content list into a format and the like that the user terminal device 200 may display (D30), and issues it to the user terminal device 200 (D40).

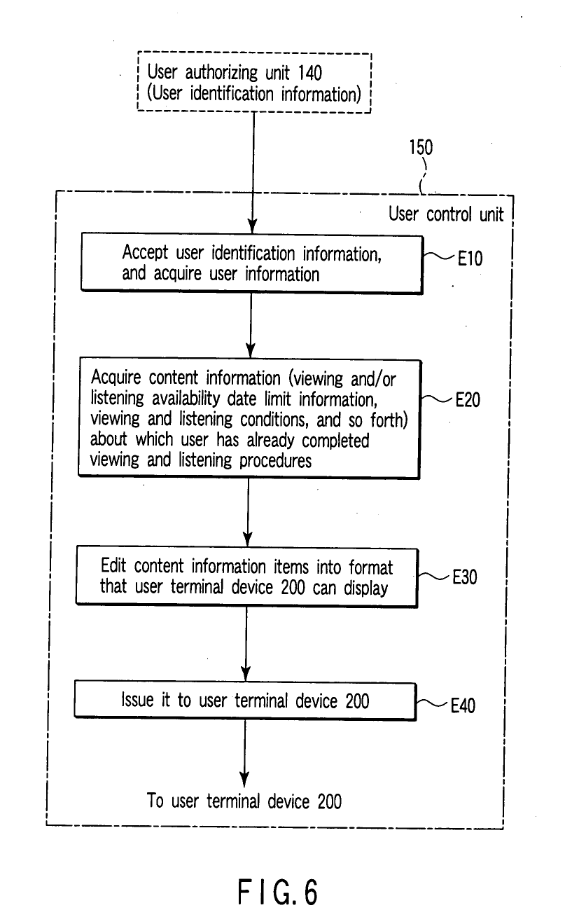

The user control unit 150, as shown in FIG. 6, reads content information (viewing and/or listening availability date limit information, viewing and/or listening conditions, and so forth) about which the user has already completed viewing and/or listening procedures from the user information accumulating unit F1(E10, E20), edits these content information items into a format that the user terminal device 200 may display as viewable and/or listenable content lists and the like (E30), and issues them to the user terminal device 200 (E40).

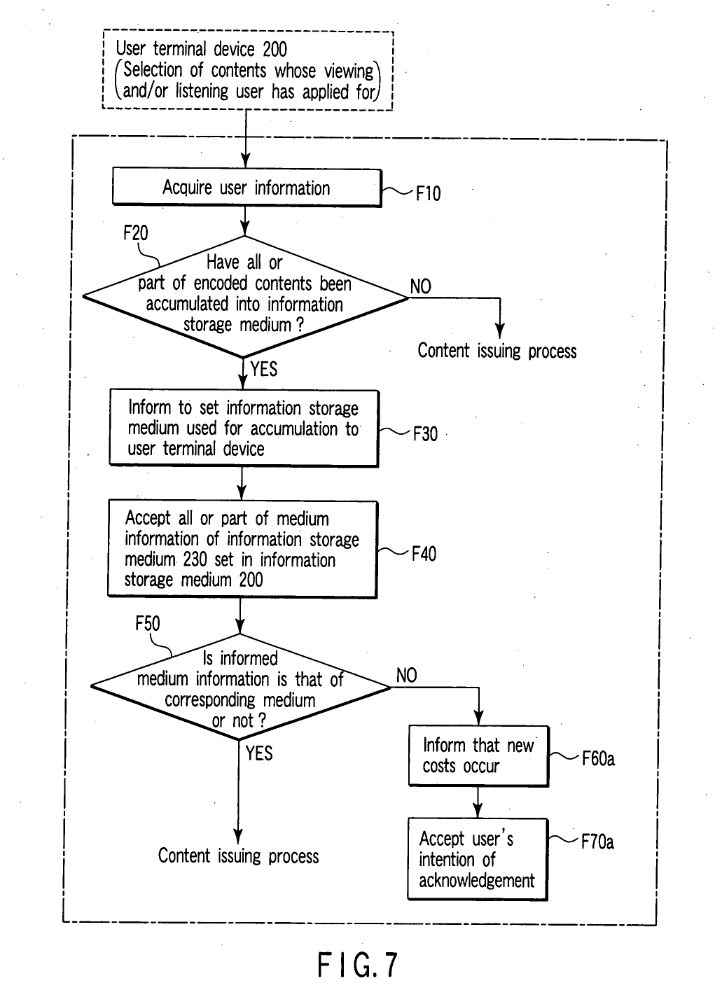

Further, the user control unit 150, as shown in FIG. 7, when the user select contents whose viewing and/or listening the user has applied for from the viewable and/or listenable content lists by the user terminal device 200, reads the user information from the user information accumulating unit F1 (F10), and determines whether all or part of encoded contents have been viewed and/or listened or accumulated into the information storage medium 230 and the like (F20). As a result of the determination, if they have not been accumulated, the procedures goes to content issuing process. If they have been accumulated, the user control unit instructs the user to set the information storage medium 230 used for accumulation to the user terminal device 200 (F30).

After the user sets the corresponding information storage medium 230 to the user terminal device 200, when all or part of medium information of the information storage medium 230 set from the user terminal device 200 is informed from the user terminal device, this medium information is accepted (F40), and by comparison with already registered medium information, it is determined whether the informed medium information is that of the corresponding medium or not (F50). As a result of the determination, if it corresponds, the procedures go to the content issuing process. If the user cannot set the corresponding information storage medium 230, a notice that new costs occur is informed to the user (F60a), and user's intention of acknowledgement is accepted from the user terminal device 200 (F70a).

Herein, part of the encoded content accumulation information at the previous accumulation may be kept in the user information, and the information may be requested and referred to at the moment of medium determination. If it is determined that it is the same medium, information on how much information amount is stored in the medium may be acquired, and compared with the information amount at the previous time.

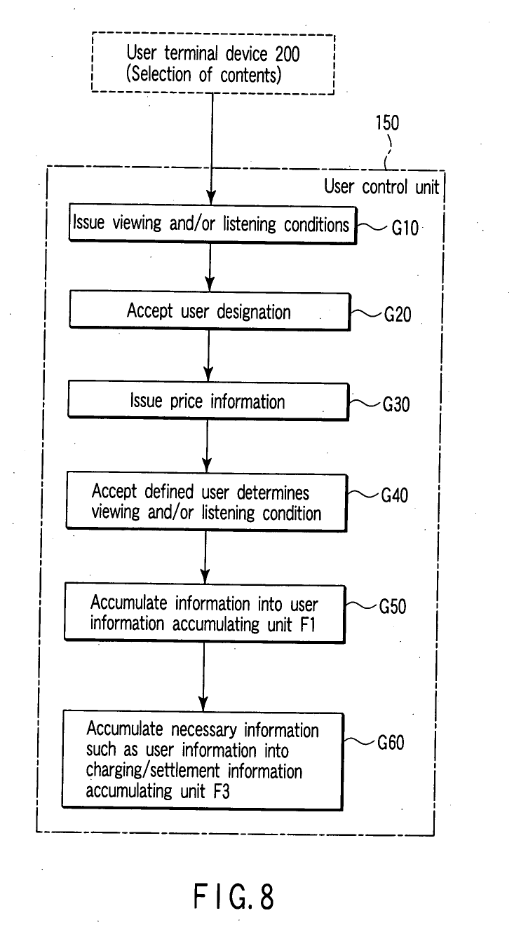

Further, the user control unit 150, as shown in FIG. 8, when the selection of contents is informed from the user terminal device 200, issues viewing and/or listening conditions to determine service modes such as the viewing and/or listening time limit to the selected contents and so forth (G10). Herein, the viewing and/or listening condition means a viewing and/or listening time limit, and by this viewing and/or listening time limit, price information of the contents accumulated in a content information accumulating unit F2 is read, and prices are determined. As modes of the viewing and/or listening condition, settings may be made in unit of fixed days such as 2 days, 4 days, 8 days and the like, and also in unit of days by user's free choice, and at receiving of user's designation input (G20), price information is issued (G30).

Further, as other viewing and/or listening conditions, designation by the number of viewing and/or listening times, designation in unit of hour and minute, image quality (HD, SD, and so forth), and designation combining these may be set (G20), and price information is issued according to these designations (G30). With regard to the price information, price adjustment results by discount rates based on user information, use of points, and the like, may be taken in.

The user control unit 150, when the user determines the viewing and/or listening condition through the user terminal device 200 (G40), accumulates selected content information, selected date and time information, viewing and/or listening condition, price information and so forth as user information into the user information accumulating unit F1 (G50), and accumulates necessary information such as user information and the like into a charging/settlement information accumulating unit F3 (G60).

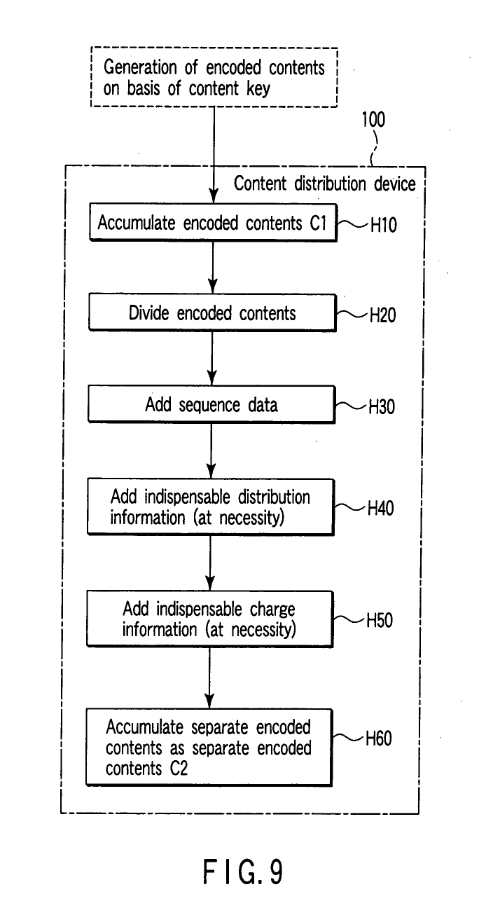

On the other hand, in the content distribution device 100, as shown in FIG. 9, encoded contents C1 generated on the basis of a content key in advance are accumulated (H10), and the encoded contents are divided into a specified unit by the data dividing unit 170. Further, sequence data showing the number of divided pieces and the sequence thereof is added to each divided encoded content, and when corresponding data is not distributed at necessity, indispensable distribution information that makes viewing and/or listening unavailable is added thereto (H50), and, when corresponding data is distributed at necessity, indispensable distribution information that makes viewing and/or listening accessible for charges is added thereto (H50), and divided encoded contents are accumulated as divided encoded contents C2 (H60). It is not always required to carry out the separating process of encoded contents in advance, but they may de divided at the moment of distribution and distributed with addition of sequence data and the like.

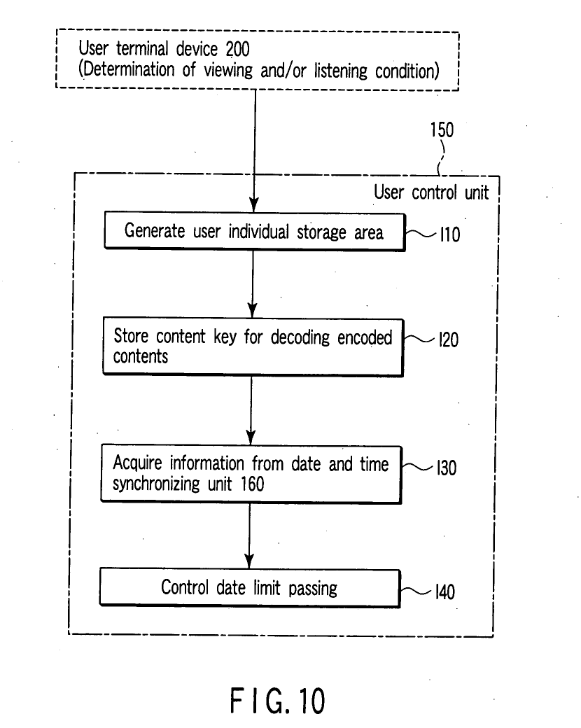

The user control unit 150, as shown in FIG. 10, after the user determines the viewing and/or listening condition by the user terminal device 200, generates a user individual storage area for storing encoded contents, encoded content key and the like based on the user's selection (110), and stores a content key for decoding encoded contents in encoded status in this storage area (120). Herein, in order to determine date limit passing in precise manners, the user control unit acquires date and time information from the date and time synchronizing unit 160 (130), and controls the presence or absence of date limit passing on the basis of this date and time information (140).

The date and time synchronizing unit 160 is a unit that acquires precise date and time by use of a communication line from a known date and time issuing device and the like, and issues the date and time that it holds in response to a request to a request source.

The user control unit 150, when the user selects the viewing and/or listening condition by the user terminal device 200, issues the user information and the like and the content information that the user has selected, together with the user individual storage area information to the encoded content key acquiring unit 180.

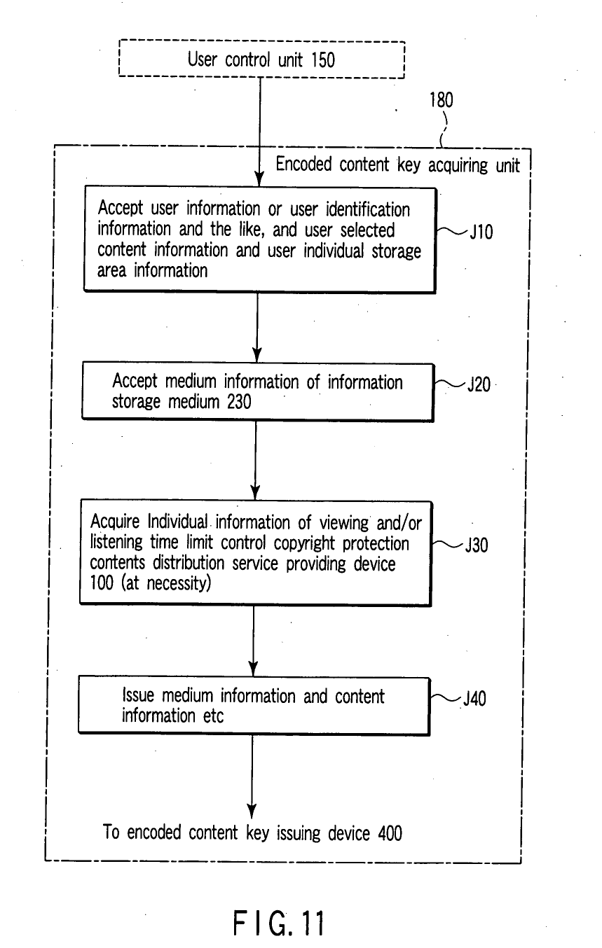

The encoded content key acquiring unit 180, as shown in FIG. 11, accepts the user information or the user identification information and the like and the content information that the user has selected and the user individual storage area information (J10), accepts the medium information of the information storage medium 230 that has been set to the user terminal device 200 from the user terminal device 200 (J20), adds the individual information and the like of the content distribution device 100 at necessity (J30), and issues them to the encoded content key issuing device 400 (J40). Herein, as information to be issued to encoded content key issuing device 400, the encoded content key acquiring unit issues at least the medium information and the content information that the user has selected.

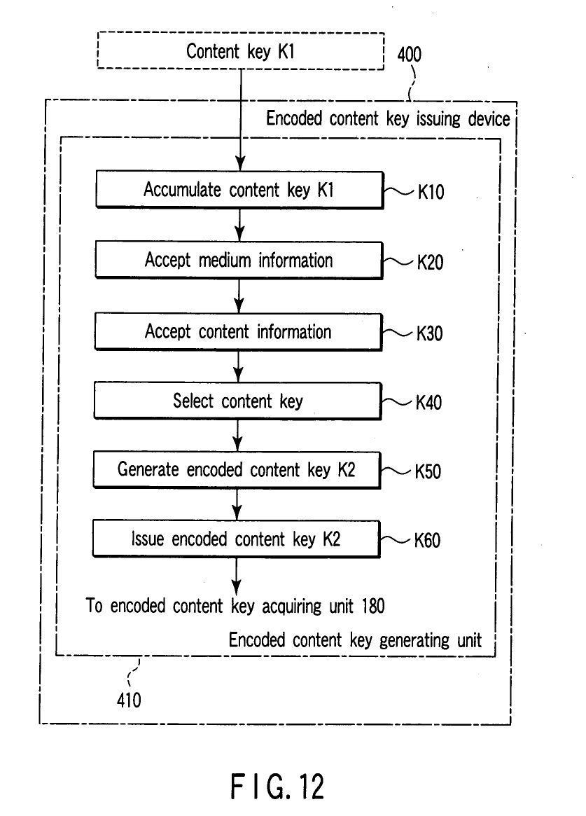

The encoded content key issuing device 400, as shown in FIG. 12, accumulates a content key K1 for decoding encoded contents (K10). At this moment, the encoded content key generating unit 410 accepts the medium information of the information storage medium 230 acquired via the communication line 300 from the encoded content key acquiring unit 180 (the medium key information and the medium specific identifier written in a read only area of the information storage medium 230) (K20), accepts the content information that the user has selected (K30), selects a content key corresponding to encoded contents on the basis thereof (K40), encodes the content key on the basis of the registered device specific key information and the medium information of the information storage medium 230 and thereby generates an encoded content key K2 (K50), and issues the encoded content key to a request source such as encoded content key acquiring unit 180 and so on (K60).

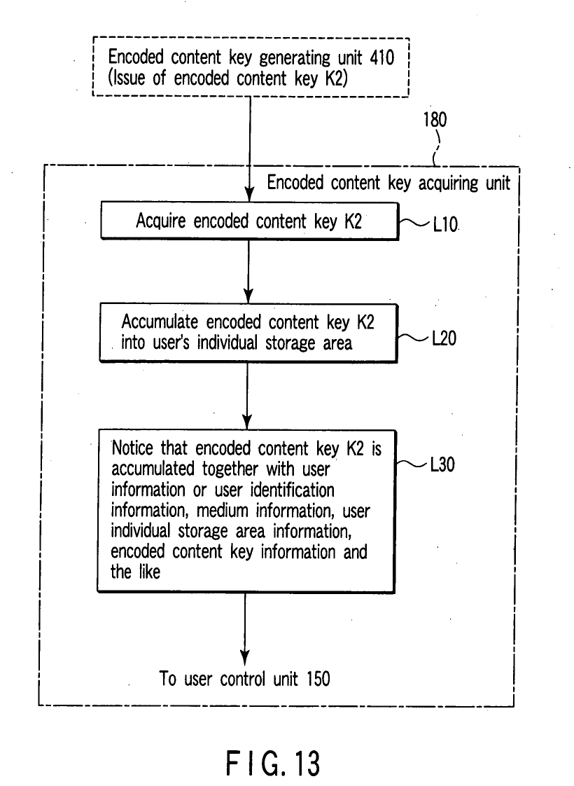

The encoded content key acquiring unit 180, as shown in FIG. 13, acquires the encoded content key K2 generated by the encoded content key generating unit 410 (L10), accumulates it into the user's individual storage area (L20), and issues the notice to that effect together with the user information or the user identification information, the medium information, the user individual storage area information, the encoded content key information and the like to the user control unit 150 (L30).

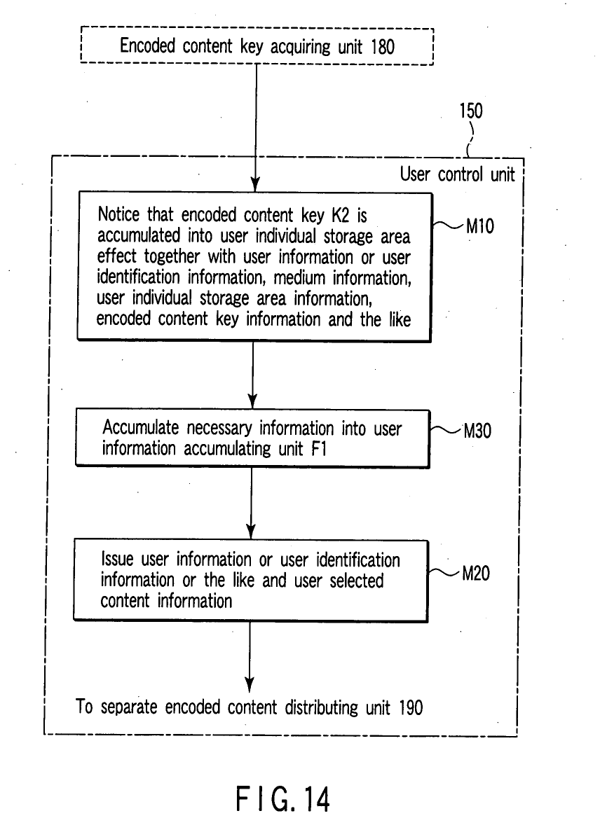

The user control unit 150, as shown in FIG. 14, accepts information from the encoded content key acquiring unit 180 to the effect that the encoded content key acquiring unit 180 has acquired the user information or the user identification information, the medium information, the user individual storage area information, the encoded content key information and the like together with the encoded content key, and stored them into the user individual storage area (M10), accumulates necessary information into the user information accumulating unit F1 (M20), and issues the user information or the user identification information or the like and the content information that the user has selected to the divided encoded content distributing unit 190 (M30).

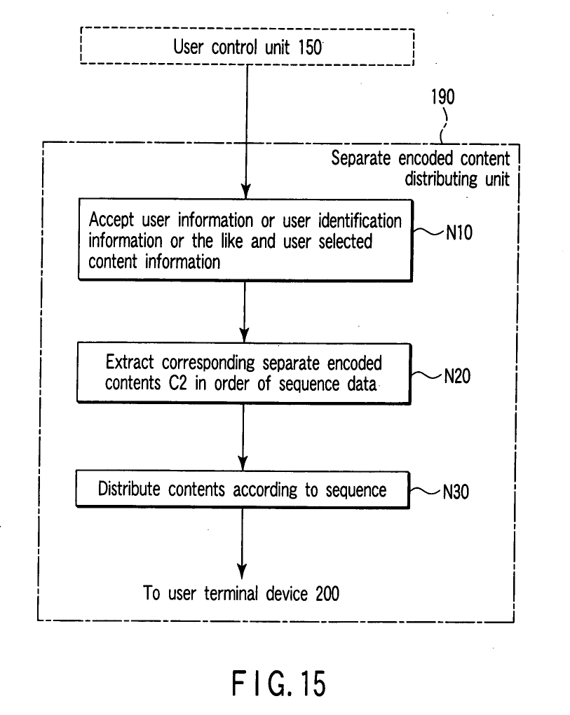

The divided encoded content distributing unit 190, as shown in FIG. 15, accepts the user information or the user identification information or the like and the content information that the user has selected (N10), takes out corresponding divided encoded contents C2 in the order of the sequence data (N20), and distributes them in this sequence via the communication line 300 to the user terminal device 200 (N30).

Herein, when corresponding data is not distributed at necessity, when there is indispensable distribution information that makes viewing and/or listening unavailable, it is distributed with priority. When there is indispensable charge information that makes distribution of corresponding data charged, a notice whether to charge or not is issued to the user terminal device 200, and corresponding data is distributed after charge determination confirmation information is received from the user terminal device 200 or the user control unit 150 and the like. Further, when there is a distribution request for other data (data whose original distribution sequence is behind) from the user terminal device 200 and the like owing to viewing and/or listening item selection operations and the like such as fast forwarding operation, chapter transition operation and thumbnail at the user terminal device 200, corresponding data is distributed with priority.

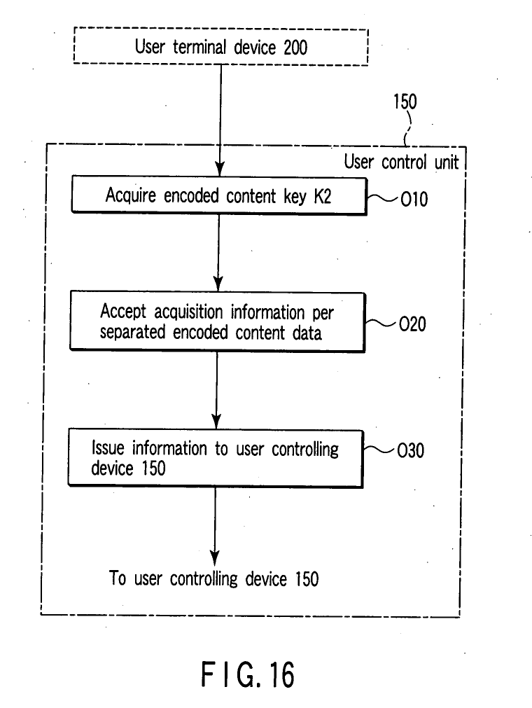

The divided encoded content distributing unit 190, as shown in FIG. 16, acquires the encoded content key K2 in response to the request from the user terminal device 200 (O10), accepts acquisition information per separated encode content data (O20), and issues information about to what time data has been distributed to the user terminal device 200 to the user controlling device 150 (O30).

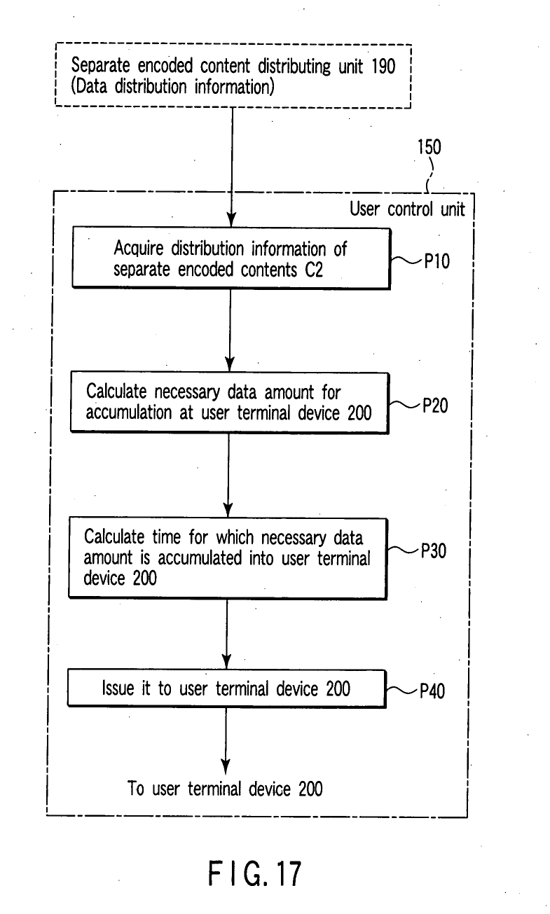

The user control unit 150, as shown in FIG. 17, on the basis of the information about to what time data has been distributed from the divided encoded content distributing unit 190, calculates necessary data amount for accumulation at the user terminal device 200 from the distribution condition of the divided encoded contents C2 distributed to the user terminal device 200, and the replay speed at which the user views and/or listens to the contents to the end thereof at normal replay speed by the user terminal device 200 (P10, P20). Further, the user controlling device calculates the time for which the data amount is accumulated into the user terminal device 200 from the distribution speed via the communication line 300 and the accumulation speed of the user terminal device 200 and the like (P30), and issues it to the user terminal device 200 (P40).

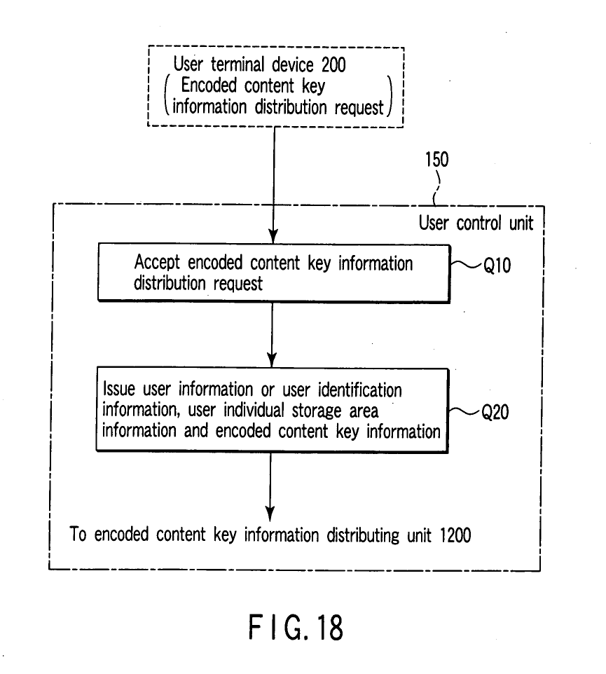

The user control unit 150, as shown in FIG. 18, accepts the encoded content key information distribution request from the user terminal device 200 (Q10), and issues the user information or the user identification information, the user individual storage area information and the like and the corresponding encoded content key information accumulated in the user individual storage area to the encoded content key information distributing unit 1200 (Q20).

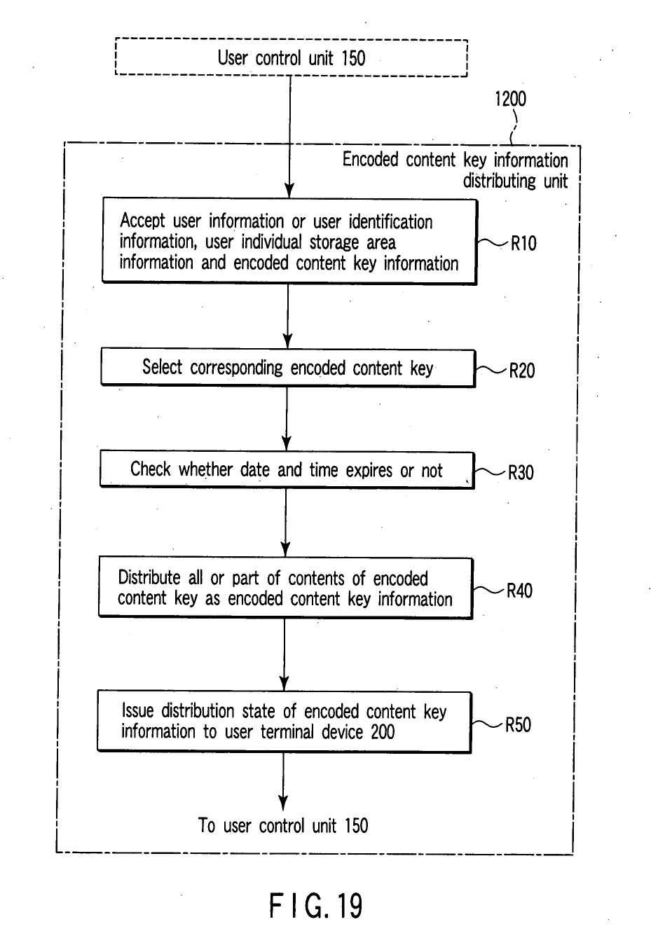

The encoded content key information distributing unit 1200, as shown in FIG. 19, accepts the user information or the user identification information, the user individual storage area information and the like and the corresponding encoded content key information accumulated in the user individual storage area (R10), selects corresponding encoded content key (R20), checks whether the date and time expires or not from the user information and the like (R30), and distributes all or part of contents of the encoded content key as encoded content key information to the user terminal device 200 (R40). Further, it issues the distribution condition of the encoded content key information to the user terminal device 200 to the user control unit 150 (R50).

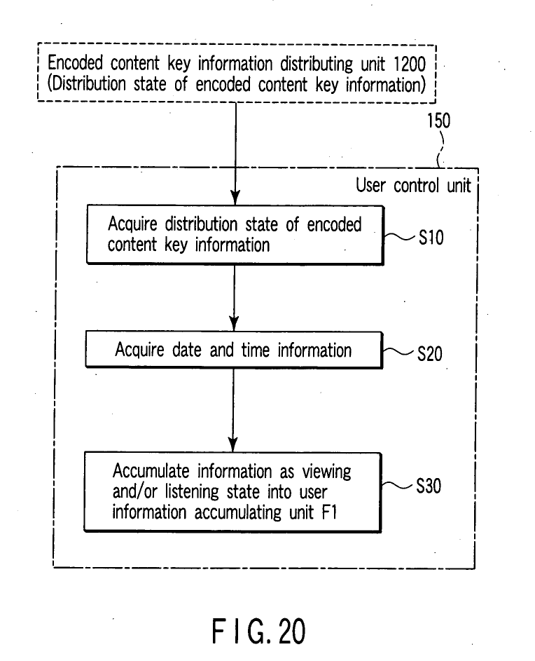

The user control unit 150, as shown in FIG. 20, acquires the distribution condition of the encoded content key information (S10), acquires the date and time information (S20), and accumulates them as viewing and/or listening condition into the user information accumulating unit F1 (S30).

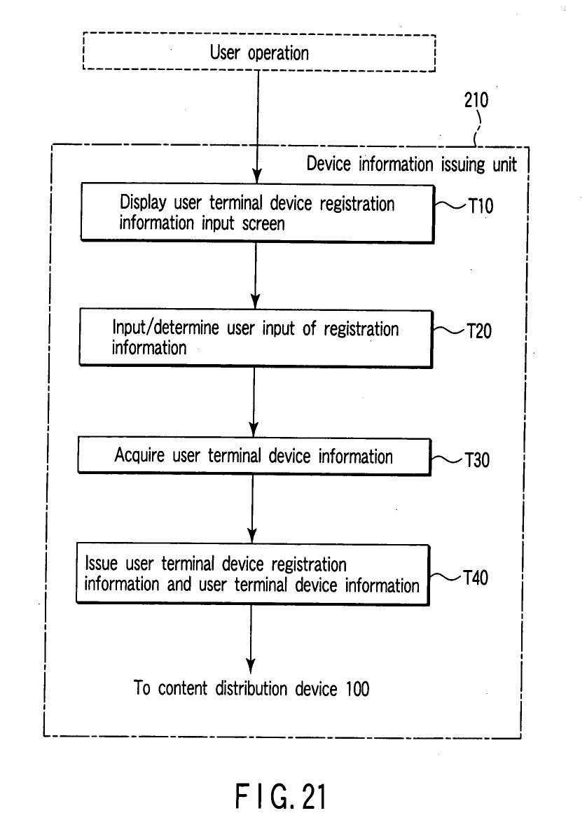

In the user terminal device 200, when the user carries out operations for receiving the services, the device information issuing unit 210, as shown in FIG. 21, displays the user input screen of the user terminal device registration information distributed by the previous service subscription application (T10), accepts and determines the user input of the registration information (T20), acquires the user terminal device information accordingly (T30), and issues it together with the user terminal device registration information that the user has input to the content distribution device 100 (T40). Herein, it is preferable that the user terminal device information is unique information.

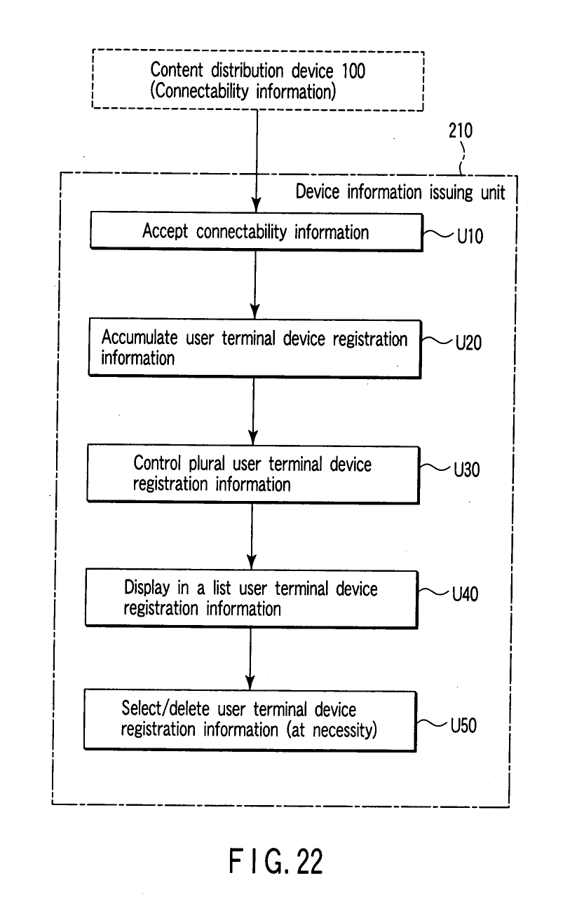

Thereafter, the device information issuing unit 210, as shown in FIG. 22, accepts information that is recognized to be connectable, from the content distribution device 100 (U10), accumulates the user terminal device registration information (U20), controls plural user terminal device registration information (U30), and display in a list the user terminal device registration information registered by user operations (U40).

Herein, the user terminal device registration information is selected, and may be deleted at necessity. At this moment, it is necessary to input authorization information, and after input, the content distribution device 100 is accessed, and the contents are collated with the contents registered in the user information accumulating unit F1. Only when determination result information that deletion is available is accepted, deletion is available (U50).

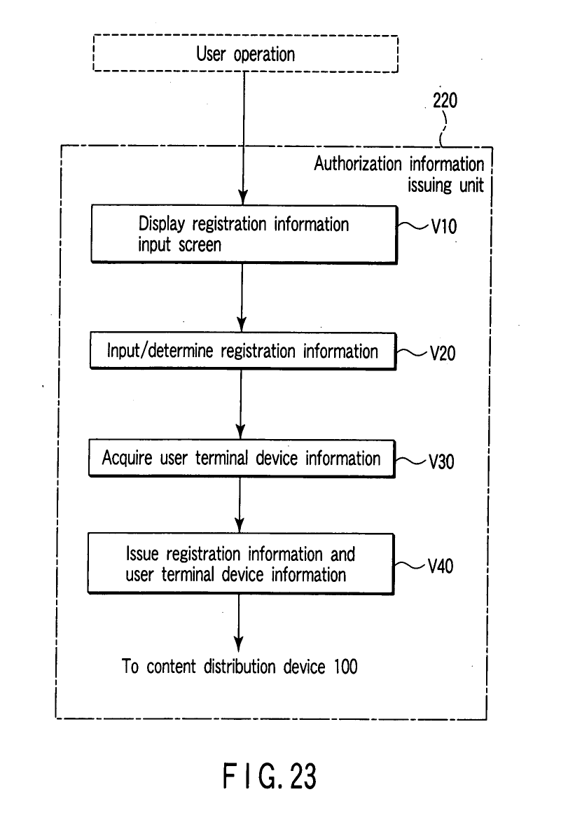

Further, in the user terminal device 200, after registration of the user terminal device registration information, when the user carries out operations for receiving the services, the authorization information issuing unit 220, as shown in FIG. 23, displays the user input screen of the user terminal device registration information distributed by the previous service subscription application (V10), and accepts and determines the user input of the registration information (V20). Along with this, it acquires the user terminal device information (V30), and issues it together with the user terminal device registration information that the user has input to the content distribution device 100 (V40).

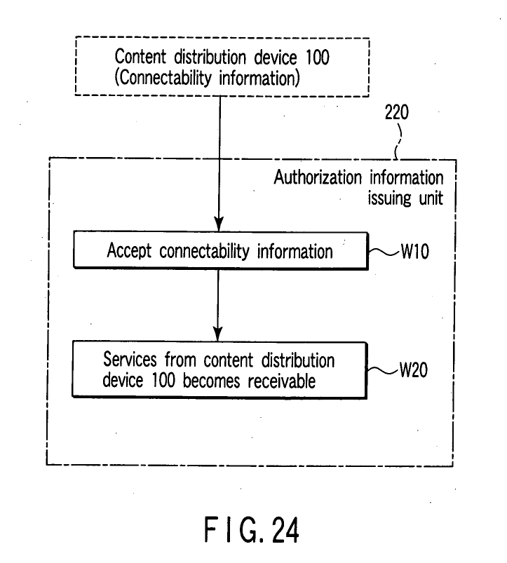

Thereafter, the authorization information issuing unit 220, as shown in FIG. 24, accepts information that is recognized to be connectable, from the content distribution device 100 (W10), and services via the communication line 300 from the content distribution device 100 becomes receivable (W20).

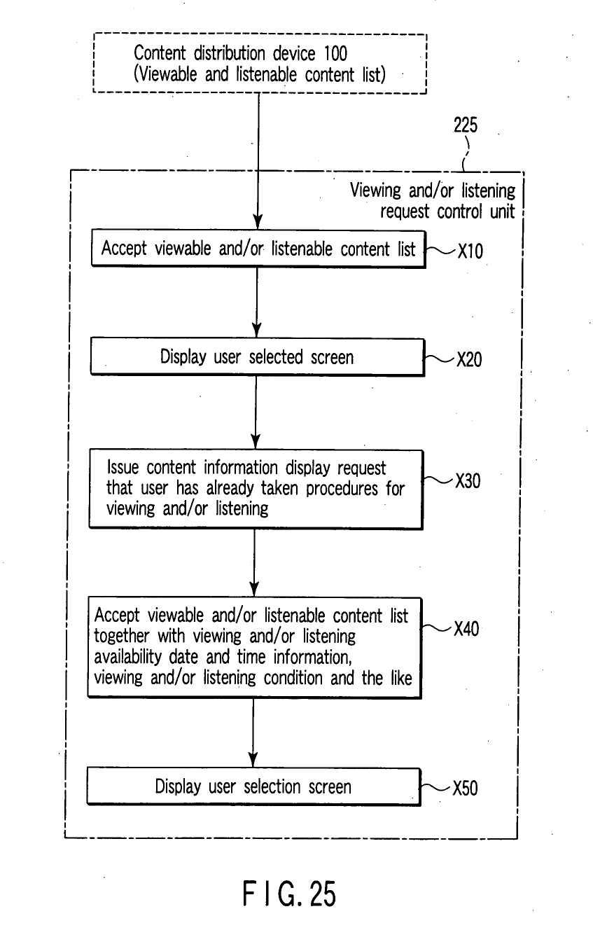

In this status, a viewing and/or listening request control unit 225, as shown in FIG. 25, accepts a content list that the user can view and/or listen to from the content distribution device 100 (X10), and displays the screen that the user selects (X20). Herein, the user makes a content information display request that the user has already taken the procedures for viewing and/or listening, and thereby the viewing and/or listening request control unit issues this content information display request that the user has already taken the procedures for viewing and/or listening to the content distribution device 100 (X30), accepts it together with viewing and/or listening availability date and time information, viewing and/or listening condition and the like as viewable and/or listenable content list from the content distribution device 100 (X40), and displays the user selection screen (X50).

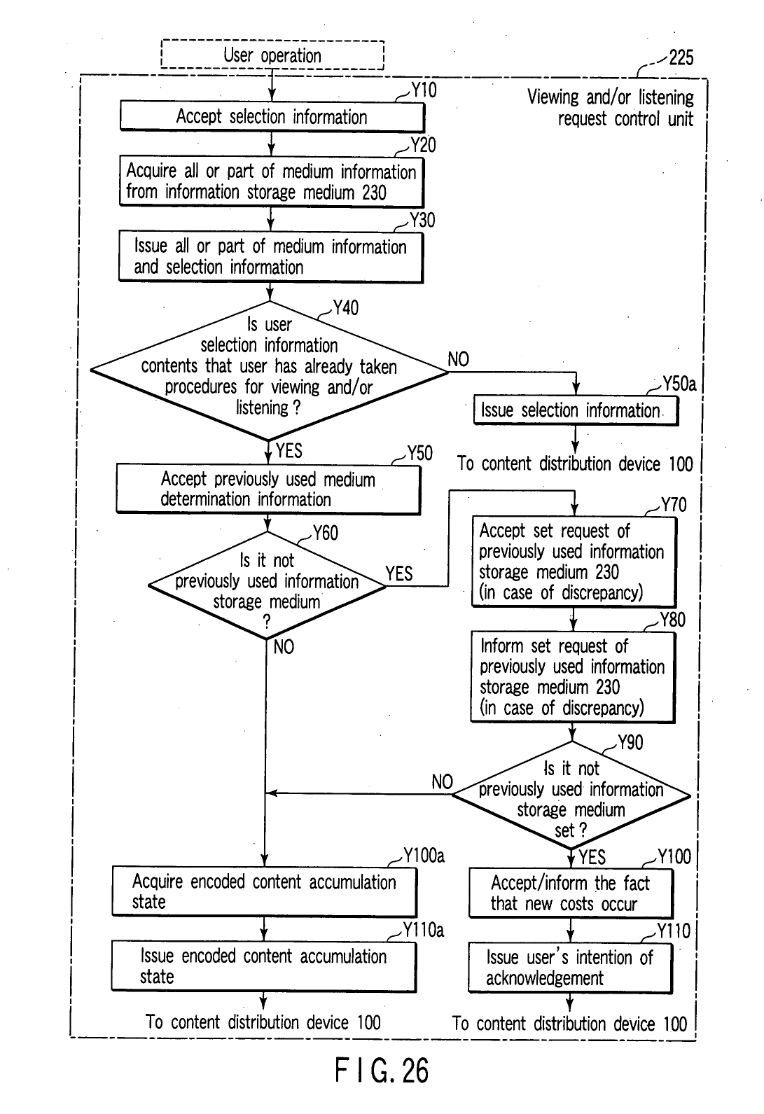

Then, the viewing and/or listening request control unit 225, as shown in FIG. 26, accepts user selection operation from the viewable and/or listenable content list (Y10), acquires all or part of the medium information from the information storage medium 230 (Y20), and issues it to the content distribution device 100 (Y30).

Herein, if the user selection information is not contents that the user has already taken the procedures for viewing and/or listening (Y40), the selection information is issued to the content distribution device 100 (Y50a). If the user selection information is contents that the user has already taken the procedures for viewing and/or listening (Y40), the viewing and/or listening request control unit accepts the previously used medium determination information from the content distribution device 100 (Y50), and if it does not meet the previously used medium determination information (Y60), accepts the set request of the previously used information storage medium 230 to the user terminal device 200 from the content distribution device 100 (Y70), and informs the user of the request (Y80).

If the user cannot set the corresponding information storage medium 230 (Y90), the fact that new costs occur is accepted from the content distribution device 100, and informed to the user (Y100), and user's intention of acknowledgement is issued to the content distribution device 100 (Y110). If the user sets the corresponding previously used information storage medium 230 to the user terminal device 200 (Y100a), encoded content accumulation state is acquired from the set information storage medium 230 (Y100a), and issued to the content distribution device 100 (Y110a).

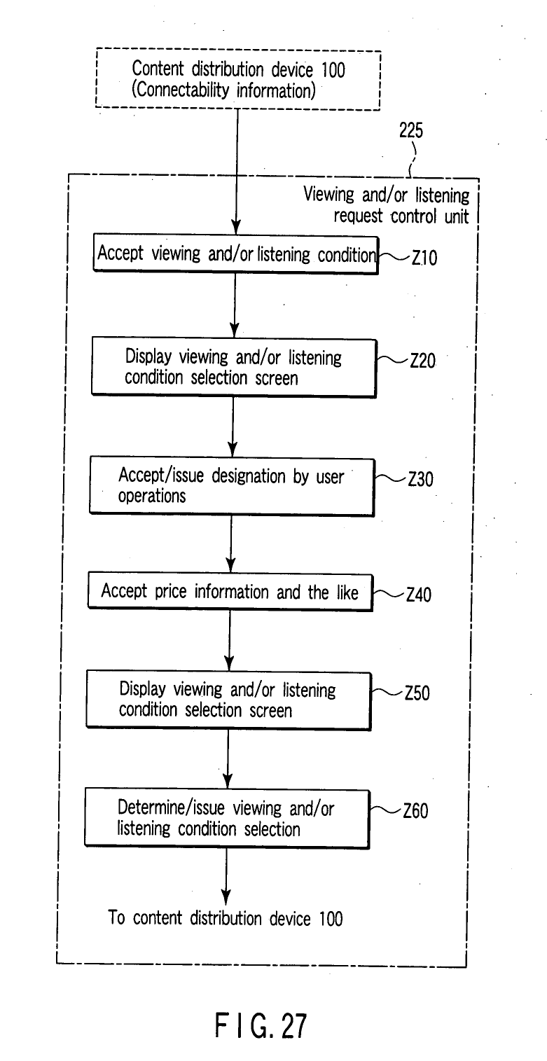

Further, the viewing and/or listening request control unit 225, as shown in FIG. 27, accepts viewing and/or listening condition to determine service modes such as viewing and/or listening time limit and the like to the contents the user has selected from the content distribution device 100 (Z10), displays the viewing and/or listening condition selection screen that the user designates (Z20), accepts a designation by user operations and issues it to the content distribution device 100 (Z30), accepts price information and the like from the content distribution device 100 (Z40), displays them on the viewing and/or listening condition selection screen that the user designates (Z50), and issues them as viewing and/or listening condition selection by user determination action to the content distribution device 100 (Z60).

Herein, as free designation, in unit of fixed days, designation by the number of viewing and/or listening times, designation in unit of hour and minute, image quality (HD, SD, and so forth), and designation combining these may be set.

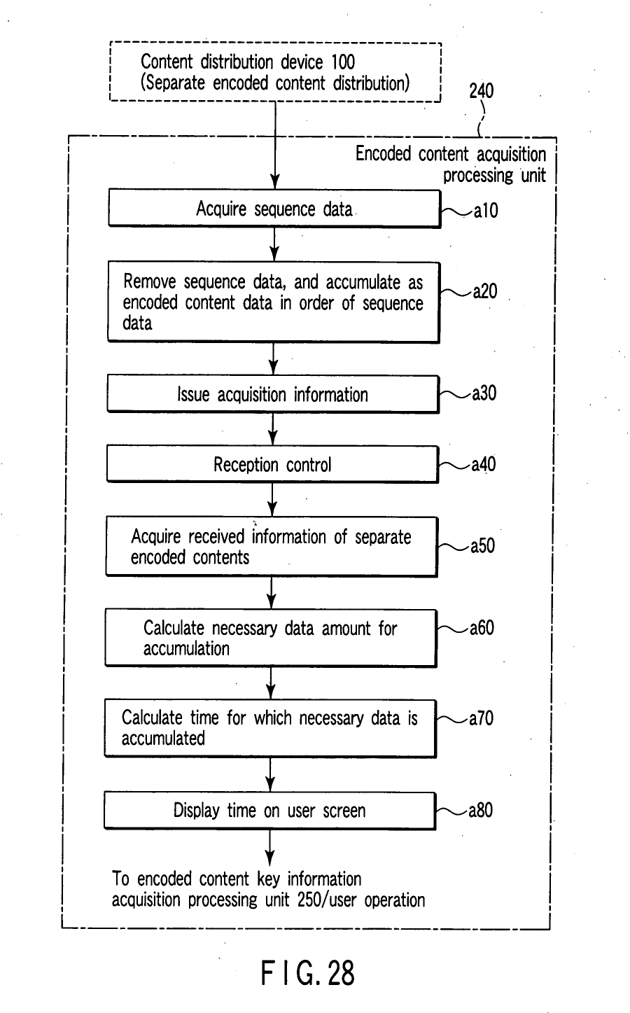

The encoded content acquisition processing unit 240, as shown in FIG. 28, accepts the divided encoded contents distributed from the content distribution device 100 and reads the sequence data (a10), removes the sequence data added by the content distribution device 100, accumulates the encoded content data in the order of the sequence data, and finally accumulates them as encoded contents (a20).

Herein, in the case of encoded contents of indispensable distribution information, they are accumulated irrespective of the sequence. In the case of encoded content data of indispensable charge information, it is issued to the content distribution device 100, and information that procedures of charging are completed is acquired from the content distribution device 100, and then data is accumulated. The medium to which the encoded content data or encoded contents are accumulated may be the storage medium 270 as well as the information storage medium.

The encoded content acquisition processing unit 240 issues the acquisition information per divided encoded content data to the content distribution device 100 (a30), and controls to which part of data has been received by the user terminal device 200 (a40).

The encoded content acquisition processing unit 240 calculates necessary data amount for accumulation at the user terminal device 200 from the accumulation state of the received divided encoded contents C2, and the replay speed at which the user views and/or listens to the contents to the end thereof at normal replay speed by the user terminal device 200 (a50, a60). It calculates the time for which the data amount is accumulated from the content distribution device 100 via the communication line 300 from the distribution speed of the communication line 300 (a70), and displays the time on the user screen (a80). The data amount and time information necessary for this accumulation may be received from the content distribution device 100. It is preferable that after the minimum necessary data amount is acquired from the content distribution device 100, the user can view and/or listen to contents.

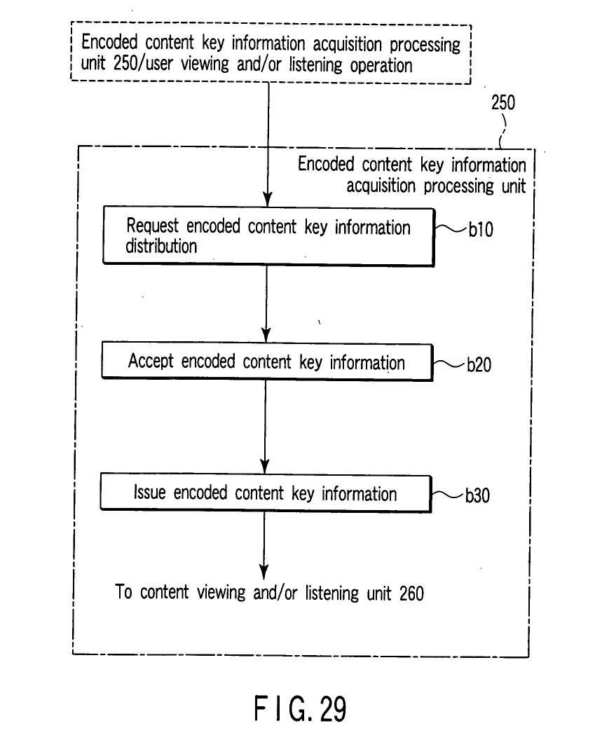

On the other hand, the encoded content key information acquisition processing unit 250, as shown in FIG. 29, issues an encoded content key information distribution request to the content distribution device 100 at user's viewing and/or listening request (b10), accepts the encoded content key information from the content distribution device 100 (b20), and issues it to the content viewing and/or listening unit 260 (b30).

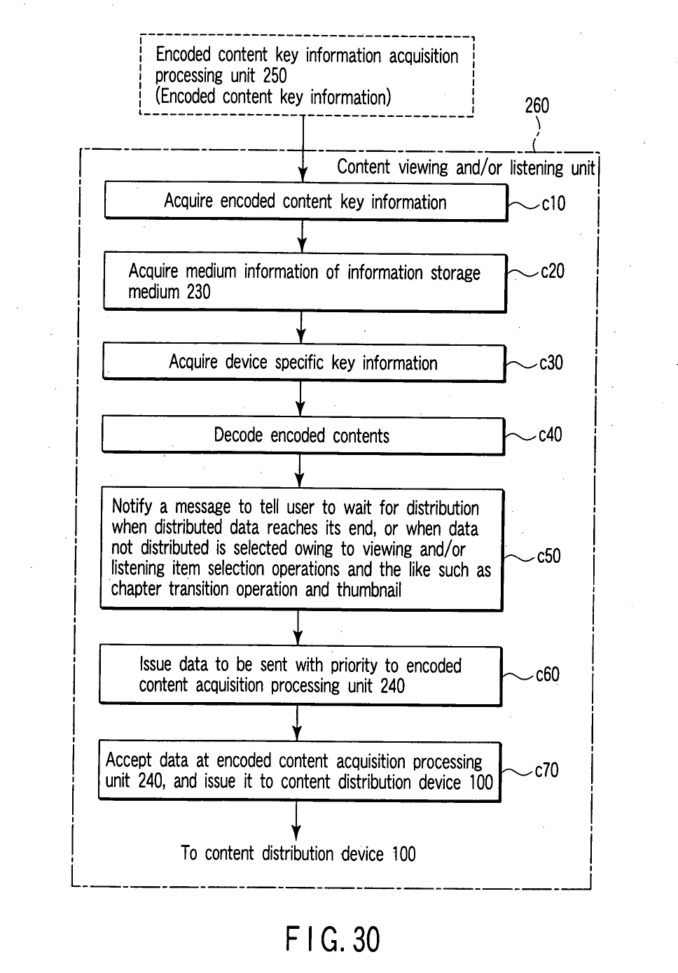

In response to this, the content viewing and/or listening unit 260, as shown in FIG. 30, decodes the encoded content data accumulated in the information storage medium 230, the storage medium 270 and the like on the basis of the encoded content key information, the medium information of information storage medium, and the device specific key information issued from the encoded content key information acquisition processing unit 250 (c10, c20, c30, c40), and thereby makes them viewable and/or listenable to the user. Herein, when it is determined that data is decoded and viewing and/or listening is ended, the objective data may be deleted.

The content viewing and/or listening unit 260, when the content distribution device 100 distributes data and viewing and/or listening is carried out, when distributed data reaches its end by user operations such as fast forwarding or so, or when data not distributed is selected owing to viewing and/or listening item selection operations and the like such as chapter transition operation and thumbnail, gives a message to tell the user to wait or the like to the user (c50), and issues data to be sent with priority to the encoded content acquisition processing unit 240 (c60). The encoded content acquisition processing unit 240 receives this, and issues it to the content distribution device 100 (c70).

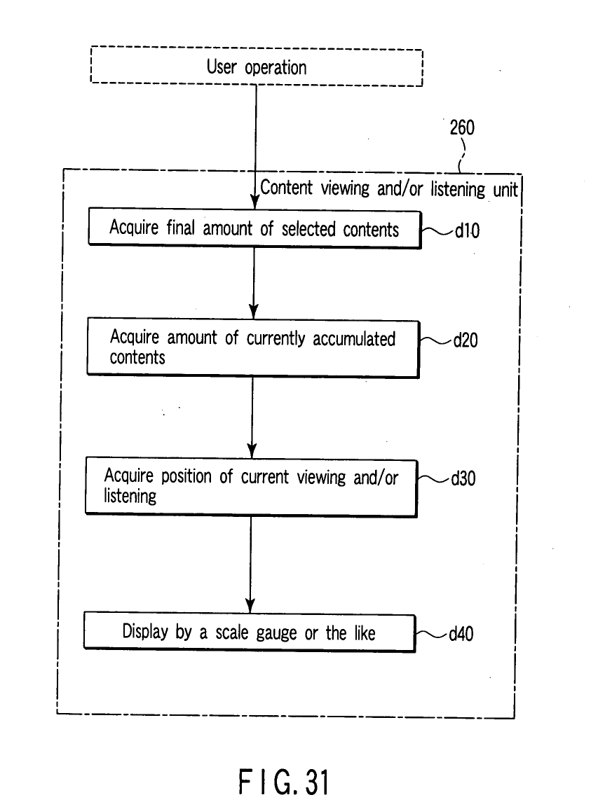

Further, the content viewing and/or listening unit 260, as shown in FIG. 31, enables the user to display the final amount of the selected contents (content volume, distribution completion scheduled time, %, and so forth), the amount of currently accumulated contents (content volume, current time, %, and so forth), and the position of current viewing and/or listening (volume so far viewed and/or listened from the beginning of contents, time information so far viewed and/or listened from the beginning of contents, %, and so forth) (d10, d20, d30, d40). It is preferable that this display is visual displayed by a scale gauge or the like.

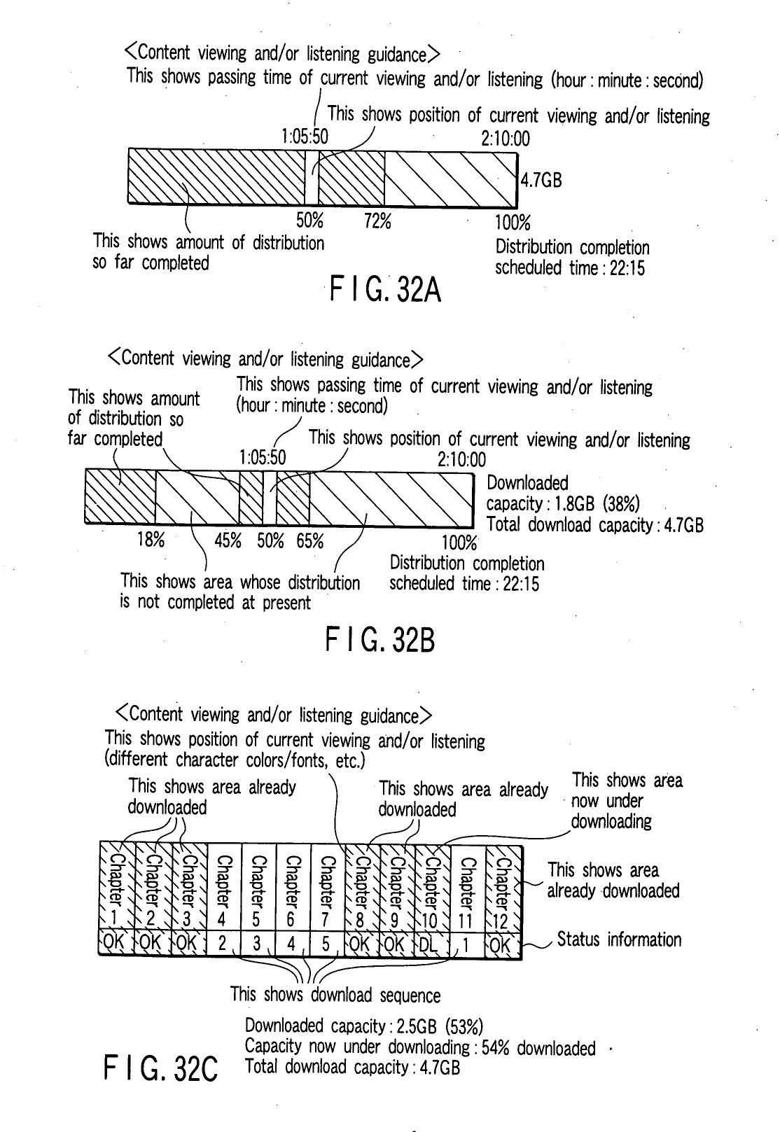

Display examples are shown in FIGS. 32A, 32B, and 32C. In FIG. 32A, contents are supposed to be sent sequentially to a DVD-RAM disk (capacity 4.7 GB) of a storage medium, and the amount of distribution so far completed, passing time of current viewing and/or listening (hour: minute: second), and distribution completion scheduled time are shown on a scale gauge. In FIG. 32B, in the case where divided contents are sent in a requested sequence, in addition to the display information items in FIG. 32A, an area whose distribution is not completed at present, and data volume are shown visually. In FIG. 32C, a download completion condition in unit of separate capture is shown visually. As status information to become the standard for grasping conditions, as shown in the figure, download completion “OK”, now downloading “DL”, and download sequence numbers may be displayed.

According to the content distribution service providing system as configured as explained heretofore, when the user carries out an easy access and content selection by use of the communication line, contents in a status the copyright thereof is protected are written into the specified information storage medium 230 or the storage medium 270, and stable viewing and/or listening is available. It is possible to realize an effective content distribution service that enables the control of effective viewing and/or listening time limit and distribution to terminal device and efficient distribution with viewing and/or listening time limit.

Herein, the content distribution device 100 and the user terminal device 200 use the communication line 300. For connections among other devices, besides the communication line 300, other information transmission means including a directly connected wire, a circuit, a storage medium and so forth may be employed.

Further, the components in the content distribution device 100 may be loaded in the content distribution device 100, or connected thereto, or arranged independently.

Further, the components in the user terminal device 200 may be loaded in the user terminal device 200, or connected thereto, or arranged independently.

Further, the information storage medium 230 may be a DVD-RAM disk or the like that has a read only area and a write area, and has medium key information corresponding to various user devices and a medium specific identifier kept per medium in the read only area, and it is not limited to a disk shaped medium, but a tape shaped medium or a semiconductor information medium or the likes (memory, IC card, and so forth) may be employed.

Further, the storage medium 270 is not limited to an information storage medium that has a read only area and a write area such as a DVD-RAM disk or so, but may be a medium that records information such as a disk shaped medium, a tape shaped medium, a semiconductor information medium or the likes (memory, IC card, and so forth).

In the above embodiment, the place to store the encoded content key and the encoded contents is not limited to an information storage medium where medium information exists in the read only area thereof, but may be other storage media.

For example, encoded contents may be stored in a hard disk, and the encoded content key may be memorized into an information storage medium such as a DVD medium or so.

Further, both the encoded contents and the encoded content key may be stored into a hard disk, and an information storage medium such as an IC card, DVD medium and the like may read them at the user side device, then downloading and viewing and/or listening may be realized.

Further, in the above embodiment, when a medium for CPRM (for example, a DVD) is used as the information storage medium 230, the cooperative application of the encoded content acquisition processing unit 240 may read MKB hash value (existing as MKB identification information in the read only area in a medium in the same manner as MKB) in the read only area of a medium for CPRM, and may be sent via the encoded content key acquiring unit 180 to the encoded content key generating unit 410. Thereby, it is possible to reduce the information transmission amount.

Further, it is preferable that the encoded content key information is stored in a temporal memory of the user terminal device 200, and the timing to delete information is preferably at the end of viewing and/or listening to contents, at stop of viewing and/or listening to contents, at turning off the user terminal device, at stop of the user terminal device, at unloading of an information storage medium, at communication disconnection with the content distribution device, and so forth.

The timing for charging may be, besides the moment of viewing and/or listening condition selection, at the timing when part or all of encoded contents are stored into the information storage medium, or at the timing when the encoded content key is stored into the user individual area, or at the timing when the encoded content key is issued to the user terminal.

Viewing and/or listening condition selection may be designated before content selection, as well as after content selection, and contents to meet the condition may be displayed in a content list. Further, during viewing and/or listening to contents, according to the information controlled by the content distribution device 100 or the user terminal device 200, or the information in encoded contents, viewing and/or listening condition may be determined and selected.

Further, the information to determine whether viewing and/or listening time limited contents or not may be put in the encoded content key or the encoded contents.

Furthermore, at a specified timing during viewing and/or listening distribution contents, encoded content key distribution may be requested. In this case, at occurrence of encoded content key distribution request in the course, a method to notify that viewing and/or listening from now will be charged may be adopted. Further, the timing of encoded content key distribution may be generated periodically by the device itself, during viewing and/or listening to contents.

Moreover, in the user terminal device 200, the encoded content key acquired from the content distribution device 100 may be decoded by use of the medium information and the device specific key information, and the decoded content key may be encoded once again by use of the device specific key information of the user terminal device 200, and the same medium information as at decoding or other medium information, thereby the encoded content key may be generated.

In addition, in the user terminal device 200, by use of the medium information and the device specific key information, the encoded content key may be decoded, by use of the decoded content key, the encoded contents may be decoded, by use of the encoding function that the user terminal device 200 has, the content key may be re-generated, the content key may be encoded once again, and contents may be encoded once again.

Further, in consideration of a case where the user wants an expansion of the content viewing and/or listening valid period or the valid number of viewing and/or listening times, by sending a viewing and/or listening condition change request from the user terminal device 200 to the content distribution device 100, at the content distribution device 100 side, the viewing and/or listening condition control information of the corresponding user may be changed. In the case of an expansion, charging process may be made accordingly.

Further, there may be a case where the user after viewing and listening to distributed contents wants to purchase the contents. Therefore, purchase of contents may be requested from the user terminal device 200 to the content distribution device 100. At the content distribution device 100 side, a key storage permission may be issued in response to the content purchase request, and at the user terminal device 200 side, the permitted encoded content key or the content key to be generated from the encoded content key may be embedded into the information storage medium, and thereby recorded contents may be decoded and replayed at any time.

Further, among the divided encoded contents, divided contents of the predetermined indispensable distribution may be sent, and other divided contents may be distributed by an optional designation, or among the divided encoded contents, by a viewing and/or listening request for predetermined divided contents, a charging process may be executed, thereby, it is possible to increase convenience by content division.

Furthermore, as an effect of content division distribution, it is possible to use the indispensable distribution area as a commercial advertisement section, thereby it is possible to expect incomes of advertisement charges, and to contribute to a stable system operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1-3. (canceled)

4. A content distribution device of a content distribution service providing system for carrying out distribution services of contents whose copyright protection is required via a communication line, to a user terminal device that enables recording contents to an information storage medium in which medium information of a medium specific identifier and medium key information are written, or to another information storage medium different from the information storage medium in a status where the information storage medium is set, comprising:
content distribution request acquisition means for receiving a content distribution request based on a content selection list to be distributed in advance, from the user terminal device;
viewing and/or listening condition acquisition means for distributing a viewing and/or listening condition list including at least one of a viewing and/or listening valid period and the number of viewing and/or listening times to the user terminal device that has made the request at receiving of the content distribution request, and receiving a viewing and/or listening condition selection result thereof;
medium information control means for acquiring and controlling the medium information from the user terminal device;
encoded content control means for encoding and controlling contents specified in the content selection list by a predetermined content key, and distributing encoded contents corresponding to the content distribution request to the user terminal device that has made the request;
encoded content key acquisition means for sending the medium information to an encoded content key issuing device, asking it to encode a content key used in encoding the distribution contents on the basis of the medium information and device specific key information registered in advance, and receiving the encoded content key;
encoded content key distribution means for distributing an encoded content key corresponding to the user terminal device that has made a viewing and/or listening request according to a viewing and/or listening request for already distributed encoded contents, from the user terminal device; and
user control means for controlling the viewing and/or listening conditions in unit of user, and determining whether viewing and/or listening conditions are satisfied or not at the viewing and/or listening request, wherein
the encoded content key distribution means distributes the encoded content key only when it is determined that viewing and/or listening conditions are satisfied at the viewing and/or listening request.

5. The user control means according to claim 4, wherein the user control means controls distribution history information of contents distributed to the user terminal device in unit of user; when acquiring the content distribution request or the viewing and/or listening request, refers to content distribution history information of the user; and causes the encoded content control means to distribute requested encoded contents if not distributed yet.

6. The content distribution device according to claim 4, wherein the medium information control means, at a viewing and/or listening request from the user terminal device, requests and confirms medium information at necessity.

7. The content distribution device according to claim 4, wherein in selection of contents by the content selection list, quality of contents can be selected.

8. The content distribution device according to claim 4, wherein the encoded content control means puts information for requesting the encoded content key in the encoded contents in the course of replaying contents.

9. The content distribution device according to claim 4, wherein the encoded content key distributing means distributes the encoded content key in response to a key distribution request that is made in the course of replaying contents.

10. The content distribution device according to claim 4, wherein the encoded content control means divides the encoded contents into plural contents and controls them, and distributes the divided encoded contents selectively or sequentially or in a designated order according to a distribution request mode from the user terminal device.

11. The content distribution device according to claim 10, wherein the encoded content control means sends divided contents of predetermined indispensable distribution, among the divided encoded contents, and distributes other divided contents by an optional designation.

12. The user control means according to claim 10, wherein the user control means executes a charging process by a viewing and/or listening request for predetermined divided contents, among the divided encoded contents.

13. The user control means according to claim 4, wherein the user control means further controls a content distribution history including the viewing and/or listening conditions, acquires a content accumulation state from the user terminal device at a content viewing and/or listening request, compares and collates it with a content recording state under distribution at present, and grasps the portion that is not distributed yet in contents from the collation result.

14. The content distribution device according to claim 4, wherein the encoded content control means, when distributing encoded contents to the user terminal device, informs at least one of a data amount required for distribution and time information.

15. The content distribution device according to claim 4, wherein the encoded content control means, at content distribution, determined whether or not all or part of encoded contents have already been recorded in the information storage medium of the user terminal device that has made a request from control information of the user control means, and if they have been already recorded, requests for at least a medium specific identifier of the information storage medium set at recording, and if matching of medium specific identifier cannot be obtained, informs that new costs occur.

16. The user control means according to claim 4, wherein the user control means accepts a viewing and/or listening condition change from the user terminal device, and carries out a charging process according to the change contents.

17. The user control means according to claim 4, wherein the user control means accepts a purchase request for distributed contents from the user terminal device, carries out a purchase charging process, and allows the request source to store the encoded content key.

18.-30. (canceled)
